(19) United States
(12) Patent Application Publication
(10) Pub. No.: US 2016/0117699 A1
(43) Pub. Date: Apr. 28, 2016

(54) QUESTIONNAIRE SYSTEM, QUESTIONNAIRE RESPONSE DEVICE, QUESTIONNAIRE RESPONSE METHOD, AND QUESTIONNAIRE RESPONSE PROGRAM

(71) Applicant: GUT FEELING LABORATORY INC., Tokyo (JP)

(72) Inventor: Gakuji TANABE, Tokyo (JP)

(73) Assignee: GUT FEELING LABORATORY INC., Tokyo (JP)

(21) Appl. No.: 14/891,036

(22) PCT Filed: May 13, 2014
(86) PCT No.: PCT/JP2014/062744

§ 371 Date: Nov. 13, 2015

(30) Foreign Application Priority Data
May 14, 2013 (JP) 2013-102538

(51) Int. Cl. G06Q 30/02; G06F 3/0488

(52) U.S. Cl. CPC G06Q 30/0203; G06F 3/0488

(57) ABSTRACT

A questionnaire system can bring about an entertaining enjoyment, inspiration, and the like and can provide an intuitive and sensuous response method. The questionnaire system collects response information and includes a questionnaire response device having a display section displaying a response result and a physical sensor and a server device capable of communicating with the questionnaire response device via a communication line. The questionnaire response device includes a response information acquirer that acquires response information on a physical action on the questionnaire response device and/or outside circumstances, a displayer that displays a response result to the questionnaire based on the acquired response information, and a response information transmitter that transmits the response information to the server device. The server device includes a response information receiver that receives the response information transmitted from the questionnaire response device and a response information storage that stores the received response information.

### TECHNICAL FIELD

The present invention relates to a technique of collecting and analyzing response information to a questionnaire using a smartphone, a tablet terminal, or the like (hereinafter, referred to as a “smart device”).

### BACKGROUND ART

Recently, in a market survey (hereinafter, referred to as a “questionnaire”) using the Internet, a respondent to a questionnaire (hereinafter, referred to as a “respondent”) can access a form-based questionnaire screen installed on a web server of a survey sponsor who prepares, distributes, collects, analyzes, and the like a questionnaire (hereinafter, referred to as a “survey sponsor”) and the respondent can input a response to the questionnaire in accordance with a predetermined instruction set by the survey sponsor.

However, main response means on a web server type questionnaire screen in the related art is often restricted to response choices using check boxes, radio buttons, and choice tabs. Accordingly, in responding to a lot of questions requested by the survey sponsor, there is a problem in that the web server type questionnaire in the related art gives a complicated impression to a respondent to feel a large burden.

Since design of a response input on the web server type questionnaire screen has a restriction in development environments that response input contents are mainly determined on the web server, there is a problem in that a result of a physical action of a respondent based on a physical sensor such as a gyro sensor built in a smart device cannot be reflected in response information to a questionnaire.

Meanwhile, response counting method and system have been proposed in which a respondent can respond to questions of a survey sponsor using a physical sensor of a smart device with a simple operation (for example, see Patent Literature 1).

On the other hand, recently, a recommendation system has been provided which has a structure for recommending products to a respondent to a questionnaire based on a response result of a questionnaire for products. A specific example thereof is a recommendation system having a structure in which, in questionnaires for estate products, highly-precise device products (such as a PC, a camera, and an automobile), financial products (such as insurance), and the like, all patterns of items representing features of products such as product specifications are presented as plural ON/OFF choices, an item desired by a respondent is set to ON, and products matching a combination of ONs are recommended.

However, in the above-mentioned structure, appropriate products to be recommended may not be searched for unless a respondent responds to questions of detailed items in a wide range. Since a respondent generally wants products with a high grade, a multiple function, and a low cost, the level of satisfaction in prices decreases as requirements in product specifications of the respondent increases. Accordingly, there is a problem in that the search result of products to be recommended may be zero or there is a high possibility that the range of products to be recommended is much narrowed.

Meanwhile, a recommendation service system has been proposed which provides information of optimal products and services based on a response to question data (for example, see Patent Literature 2).

Questionnaires using the Internet are known as described above. In such questionnaires, a questionnaire based on attributes of a respondent is provided by causing the respondent to register attribute information (such as sex, age, and interest) in advance. However, it is very difficult to grasp products in which the respondent has an interest and then to provide a questionnaire using only the attribute information acquired from the respondent. Accordingly, a questionnaire survey device has been provided in which a portal site dedicated for questionnaires using the Internet is installed, contents searched by a user as well as the user's attribute information are considered as contents in which the user has an interest, and a questionnaire based on a search history is provided to the user (for example, see Patent Literature 3).

### CITATION LIST

### Patent Literatures

Patent Literature 1: JP 2010-015325 A
Patent Literature 2: JP 2004-341784 A
Patent Literature 3: JP 2010-108119 A

### SUMMARY OF INVENTION

### Technical Problem

In the system described in Patent Literature 1, a respondent can respond to logical choices of ON/OFF which are general response choices in the questionnaires in the related art using a physical sensor of a smart device, but there is no response means capable of responding to question items requiring intuitive responds using the physical sensor. Questionnaires in the related art in the system described in Patent Literature 2 are based on the premise that a respondent clearly recognizes needs thereof. Accordingly, when a respondent does not satisfactorily recognize his or her own needs for a lot of products, it is difficult to respond to questions of a questionnaire. In this way, in the questionnaires in the related art described in Patent Literatures 1 and 2, since a method enabling a respondent to intuitively respond is not provided to the respondent, it is not possible to collect information such as latent thought, sense, tendency, and desire of a respondent as a questionnaire result.

In the questionnaire survey device described in Patent Literature 3, a questionnaire in which a respondent has an interest can be provided using a questionnaire providing method based on only the respondent's attribute information in the related art. However, for example, when a provider providing products or services gives a questionnaire, there are needs for providing the questionnaire to consumers having a high degree of intention to buy the products and the like or needs for giving a chance of enabling a respondent to the questionnaire to buy the products and the like. In the questionnaire survey device described in Patent Literature 3, the questionnaire may be provided to users not having a high degree of intention to buy products associated with the questionnaire and a high degree of interest therein. In the questionnaire survey in the related art, products or services as a questionnaire targets are designated by a company and thus a respondent cannot freely select a questionnaire target to which the respondent responds.

The present invention is made to solve the above-mentioned problems and an object thereof is to provide a questionnaire system that can cause a respondent to feel entertaining enjoyment, brainstorm, and the like using a physical sensor of a smart device instead of a method of responding to interrogative and forcible question items of a questionnaire in the related art, can provide an intuitive and sensuous response method to a respondent, and can collect information such as latent thought, sense, tendency, and desire of a respondent, which has not been clearly recognized by himself or herself, as a questionnaire result.

Another object of the present invention is to provide a questionnaire system that can cope with needs for giving a questionnaire to a consumer who has a high degree of interest in a respondent to a questionnaire and a high degree of intention to buy products and the like of a provider or giving a chance of enabling a respondent to the questionnaire to buy the products and the like. Still another object of the present invention is to provide a questionnaire system in which a respondent to a questionnaire can freely select a questionnaire target.

### Solution to Problem

A first invention relates to a questionnaire system that collects response information to a questionnaire from a respondent to the questionnaire, including: a questionnaire response device that includes a display section displaying a response result to the questionnaire on a display screen and at least one type of physical sensor selected from a touch sensor, a gyro sensor, an acceleration sensor, a pressure sensor, an illuminance sensor, a camera, and a microphone; and a server device that is capable of communicating with the questionnaire response device via a communication line, wherein the questionnaire response device includes response information acquirer that acquires response information on a physical action on the questionnaire response device and/or outside circumstances of the questionnaire response device, which are sensed by the physical sensor, a displayer that displays a response result to the questionnaire on a display screen based on the response information acquired by the response information acquirer, and a response information transmitter that transmits the response information to the server device, and wherein the server device includes a response information receiver that receives the response information transmitted from the questionnaire response device, and a response information storage that stores the response information received by the response information receiver.

According to the first invention, a physical action or the like can be input as a response by providing a respondent with a questionnaire response method using a physical sensor built in a smart device. Accordingly, without restricting the logical selection of response choices using check boxes, radio buttons, and choice tabs which were main response means to a web server type questionnaire in the related art, it is possible to provide a respondent with an intuitive and sensuous response method based on use of a physical body. Questions such as questions relevant to plural needs or the like which can be complicated using sentences can be arranged and displayed in a chart-like diagram or the like. Accordingly, by interlocking display contents with a sensor, a respondent can respond with a sensuous and simple task. A survey sponsor can reflect input information detected by the physical sensor of the smart device such as a physical action of the respondent as response data to survey topics or questions of a questionnaire in the counting result. That is, it is possible to collect information such as latent thought, sense, tendency, and desire of the respondent as the questionnaire result.

By immediately reflecting and displaying the response result to the questionnaire for the respondent, thought, sense, tendency, desire, and the like which has not been recognized by the respondent can be visualized.

Preferably, the response information is a parameter indicating the physical action on the questionnaire response device and/or the outside circumstances of the questionnaire response device, which are sensed by the physical sensor.

According to the first invention, since the parameter detected by the physical sensor can be acquired as the response information, it is possible to prepare questions of a questionnaire interlinked with movement of a smart phone or the like and thus to cause a respondent to feel entertaining enjoyment such as games.

Preferably, the response information is converted into information corresponding to the response result to the questionnaire based on a parameter indicating the physical action on the questionnaire response device and/or the outside circumstances of the questionnaire response device, which are sensed by the physical sensor.

According to the first invention, since information corresponding to the response result to the questionnaire can be acquired as the response information based on the parameter detected by the physical sensor, it is possible to collect the result of the physical action or the like of the respondent as a response to the questionnaire and to acquire intuitive and sensuous response data.

Preferably, the questionnaire response device further includes a local application storage that stores a local application capable of implementing the response information acquirer, the displayer, and the response information transmitter by combination with a customiable part including at least one type of data selected from a text, an image, a voice, and a video constituting questions of an individual questionnaire survey item, a customizable part storage that stores the customizable part, and an application constructer that constructs an application relevant to a response to the questionnaire by combining the local application stored in the local application storage and the customizable part stored in the customizable part storage, and the application causes the questionnaire response device to serve as the response information acquirer, the displayer, and the response information transmitter and causes the displayer to display the questions of the individual questionnaire survey item corresponding to the customizable part.

According to the first invention, by separating customizable parts constituting the questions of an individual questionnaire survey item and a local application for processing a physical action result of a respondent after the customizable parts are incorporated from each other and directly receiving only the customizable parts from the survey sponsor for each questionnaire survey without using an application market after a respondent once acquires the local application by download or the like, it is possible to cope with plural individual survey items with a single local application. Accordingly, it is possible to save the cost and the time required for development of an application for each individual questionnaire survey item. Since plural applications do not need to be installed in a smart device, it is possible to reduce a burden of a respondent participating in plural questionnaire surveys and thus to save memory capacity of the smart device.

Preferably, the server device further includes a product information storage that stores product information, a recommended product information selecter that selects product information to be recommended to the respondent to the questionnaire from the product information stored in the product information storage based on score information which is acquired by scoring the response information stored in the response information storage, and a recommended product information transmitter that transmits the product information selected by the recommended product information selecter to the questionnaire response device, and the questionnaire response device further includes a recommended product information receiver that receives the product information from the server device and a recommended product information displayer that displays the product information received by the recommended product information receiver.

According to the first invention, since the needs for products which have not been recognized by a respondent himself or herself and which are included in the response information can be scored, that is, quantified, it is possible to acquire data, which can be used as conditions for searching for product information to be recommended to the respondent, from abstract response information from the respondent. By using the search conditions acquired in this way, desires for product specifications which have low priority for the respondent can be removed and the product information can be searched. For example, the functions or the specifications and the prices of general products exhibit an opposite correlation, which often occurs when all the needs of the respondent are considered, due to desires of a respondent such as high-specification, multi-function, and low-cost products. Accordingly, even when there are few products to be recommended as the search result, the latent desires of the respondent can be quantified in the first invention and it is thus possible to recommend more products as products recommendable to the respondent.

Preferably, the questionnaire response device further includes a specification information storage that stores specification information of hardware specifications of the questionnaire response device and a first response information correcter that calculates a sensitivity value of the physical sensor of the questionnaire response device from the specification information stored in the specification information storage and corrects the response information acquired by the response information acquirer based on the calculated sensitivity value, and the response information transmitter transmits the response information corrected by the first response information correcter to the server device

According to the first invention, by acquiring hardware specification information of a smart device, it is possible to adjust a sensitivity difference between the physical sensors due to the hardware specification difference between smart devices, thereby enhancing reliability of response information.

Preferably, the server device further includes a sensitivity difference correction value storage that stores a sensitivity difference correction value for correcting a sensitivity difference of the physical sensor depending on a specification difference between the hardware specifications of the questionnaire response device in advance and a second response information correcter that corrects the response information stored in the response information storage based on the sensitivity difference correction value stored in the sensitivity difference correction value storage, and the response information storage stores the response information corrected by the second response information correcter.

According to the first invention, by storing the correction value for correcting the sensorivity difference between the physical sensors of the smart devices in the server device, it is possible to adjust a reaction difference between the physical sensors due to the hardware specification difference between the questionnaire response devices and thus to enhance reliability of the response information.

Preferably, the questionnaire response device further includes a formal parameter acquirer that acquires a formal parameter indicating the physical action on the questionnaire response device and/or the outside circumstances of the questionnaire response device and corresponding to at least one response to the questions of the questionnaire when the respondent to a questionnaire exercises for pre-response and a third response information correcter that corrects the response information acquired by the response information acquirer based on the formal parameter acquired by the formal parameter acquirer, and the response information transmitter transmits the response information corrected by the third response information correcter to the server device.

According to the first invention, a reference for adjusting the personal difference in an action on the smart devices between respondents or the sensitivity difference between the smart devices can be acquired in exercising in a response to a questionnaire. Accordingly, it is possible to enhance reliability of the response information based on the reliability.

Preferably, the questionnaire response device further includes a response information storage that stores the response information acquired by the response information acquirer, a communication restoration detecter that detects restoration when the communication with the server device is cut off for a predetermined period of time and then the communication with the server device is restored, and a questionnaire response information re-transmitter that re-transmits the response information stored in the response information storage to the server device when the restoration of the communication with the server device is detected by the communication restoration detecter.

According to the first invention, the response information to the questionnaire can be stored in the smart device side. Accordingly, even when the communication with the serve device is cut off during the response to the questionnaire, it is possible to continuously collect the questionnaire responses from the respondent without stop. In the first invention, the response information from the respondent can be stored in the questionnaire response device and the information on questions of the questionnaire is stored in the questionnaire response device. Accordingly, even when the communication with the server device is cut off, the respondent can continue to respond to the end of questions without the stop of presentation of questionnaire questions during the response to the questionnaire. Even when the communication is cut off after the respondent finishes to respond to all questionnaires, it is possible to appropriately transmit the questionnaire response information after the communication is restored. As a result, the respondent can continue to respond to the questionnaire without a stress for restart of the response or the like even when the communication is cut off.

The first invention also relates to a questionnaire response device having a display section displaying a response result to a questionnaire on a display screen and at least one type of physical sensor selected from a touch sensor, a gyro sensor, an acceleration sensor, a pressure sensor, an illuminance sensor, a camera, and a microphone, including: response information acquirer that acquires response information on a physical action on the questionnaire response device and/or outside circumstances of the questionnaire response device, which are sensed by the physical sensor; a displayer that displays a response result to the questionnaire on a display screen based on the response information acquired by the response information acquirer; and a response information transmitter that transmits the response information to the server device.

The first invention also relates to a questionnaire response method of causing a computer system to collect response information to a questionnaire from a respondent to the questionnaire, including the steps of: acquiring response information of acquiring the response information on a physical action on a questionnaire response device and/or outside circumstances of the questionnaire response device, which are sensed by a physical sensor; displaying of displaying a response result to the questionnaire on a display screen based on the response information acquired in the response information acquiring step; and transmitting response information of transmitting the response information to the server device.

Furthermore, the first invention also relates to a questionnaire response program causing a computer system to collect response information to a questionnaire from a respondent to the questionnaire, the questionnaire response program causing the computer system to serve as: response information acquirer that acquires the response information on a physical action on a questionnaire response device and/or outside circumstances of the questionnaire response device, which are sensed by a physical sensor; a displayer that displays a response result to the questionnaire on a display screen based on the response information acquired by the response information acquirer; and a response information transmitter that transmits the response information to the server device.

A second invention relate to a questionnaire system including: a client device that includes an input device capable of accepting an operation of a user; and a server device that communicates with the client device via a communication line, wherein the client device includes an item selection acceptor that accepts selection of a questionnaire survey item to which a user responds from at least one questionnaire survey item in response to the operation of the user, a response acceptor that accepts a response to the questionnaire relevant to the questionnaire survey item selected by the item selection acceptor in response to the operation of the user, and a response transmitter that transmits the response to the questionnaire accepted by the response acceptor to the server device, wherein the server device includes a response receiver that receives the response to the questionnaire transmitted from the client device, and wherein a privilege corresponding to the questionnaire survey item is allowed to be used by the client device when the client device transmits the response to the questionnaire using the response transmitter or when the server device receives the response to the questionnaire using the response receiver.

In the second invention, preferably, the acceptance of the selection of the questionnaire survey item by the item selection acceptor or the acceptance of the response to the questionnaire relevant to the questionnaire surveying item by the response acceptor is disabled outside a predetermined period of time set for each questionnaire survey item and/or outside a predetermined condition set for each questionnaire survey item.

According to the second invention, it is possible to set a response timing to a questionnaire survey item. Accordingly, it is possible to adjust a timing at which the questionnaire survey item is provided and thus to provide a questionnaire with a defined time or a questionnaire suitable for circumstances of a questionnaire provider side, such as questionnaires based on seasons or events.

In the second invention, preferably, the client device further includes a privilege information storage that stores privilege information on the privilege, a use request transmitter that transmits a use request of the privilege corresponding to the privilege information stored in the privilege information storage in response to the operation of the user to the server device, a determination result receiver that receives a use determination result of the privilege corresponding to the use request transmitted by the use request transmitter, and a determination information displayer that displays the determination result received by the determination result receiver on a display device, and the server device further includes a use request receiver that receives the use request of the privilege from the client device, a use determiner that determines whether the privilege corresponding to the use request received by the use request receiver is allowed to be used, and a determination result transmitter that transmits the use determination result of the privilege determined by the use determiner to the client device.

The second invention also relates to a questionnaire system including: a client device that includes an input device capable of receiving an operation of a user and a reading device reading external information; and a server device that communicates with the client device via a communication line, wherein the client device includes a questionnaire response acceptor that accepts a response to a questionnaire relevant to information acquired by the reading device, and a response result transmitter that transmits the response accepted by the questionnaire response acceptor and the information acquired by the reading device as a response result to the server device, and wherein the server device includes a response result receiver that receives the response result transmitted from the response result transmitter.

In the second invention, preferably, the response result transmitter transmits position information or time information of the client device in responding to the questionnaire as the response result.

### BRIEF DESCRIPTION OF DRAWINGS

FIG. 1 is a diagram illustrating a configuration of a questionnaire system according to an embodiment of a first invention.

FIG. 2 is a diagram illustrating a configuration of a questionnaire response device according to an embodiment of the first invention.

FIG. 3 is a diagram illustrating a configuration of a server device according to an embodiment of the first invention.

FIG. 4 is a diagram illustrating a flowchart of a process of collecting response information to a questionnaire from a respondent according to an embodiment of the first invention.

FIG. 5 is a diagram illustrating a flowchart of a process of selecting recommended product information according to an embodiment of the first invention.

FIG. 6 is a diagram illustrating a flowchart of a process of correcting response information to a questionnaire based on a sensitivity difference by physical sensors on the questionnaire response device side according to an embodiment of the first invention.

FIG. 7 is a diagram illustrating a flowchart of a process of correcting response information to a questionnaire based on a sensitivity difference by physical sensors on the server device side according to an embodiment of the first invention.

FIG. 8 is a diagram illustrating a flowchart of a process of correcting response information to a questionnaire based on a formal parameter on the questionnaire response device side according to an embodiment of the first invention.

FIGS. 9(a) to 9(c) are diagrams illustrating an example of a response screen to a questionnaire according to an embodiment of the first invention.

FIGS. 10(a) and 10(b) are diagrams illustrating an example of a method of acquiring a parameter from a physical sensor according to an embodiment of the first invention.

FIGS. 11(a) and 11(b) are diagrams illustrating an example of a response screen to a questionnaire according to an embodiment of the first invention.

FIG. 12 is a diagram illustrating the concept of a questionnaire survey item in a system according to an embodiment of a second invention.

FIG. 13 is a diagram illustrating a flowchart of a process of causing a respondent to acquire privilege information in the system according to the embodiment of the second invention.

FIGS. 14(a) to 14(c) are diagrams illustrating a questionnaire response enabled/disabled state on a display screen in the system according to the embodiment of the second invention.

FIG. 15 is a diagram illustrating a flowchart of a process of determining whether privilege information can be used in the system according to the embodiment of the second invention.

FIG. 16 is a diagram illustrating a flowchart of a process of responding to a questionnaire to which a respondent can select a product or the like to respond in the system according to the embodiment of the second invention.

### DESCRIPTION OF EMBODIMENTS

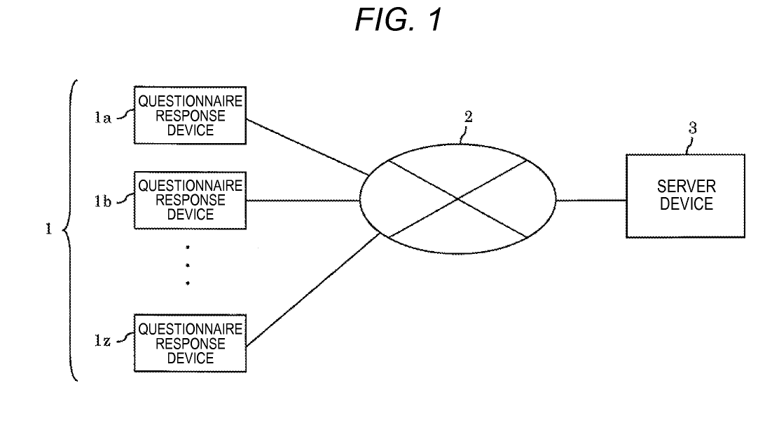

Hereinafter, an embodiment of a first invention will be described with reference to the accompanying drawings. FIG. 1 is a diagram illustrating a configuration of a questionnaire system according to an embodiment of the first invention. As illustrated in the drawing, the questionnaire system according to the first invention includes plural questionnaire response devices 1 (questionnaire response devices 1a, 1b, . . . , 1z), a server device 3, and a communication network 2. The questionnaire response devices 1 are connected to the server device 3 via the communication network 2.

The questionnaire response device 1 is a terminal which is used for a respondent to respond to a questionnaire which is provided by a survey sponsor. Examples of the questionnaire response device 1 include a smartphone, a tablet terminal, a mobile phone, and a PDA, but the first invention is not limited to these examples as long as it is a device including a physical sensor section and capable of communicating with the server device 3 via the communication network 2. The communication network 2 employs various wired or wireless known communication networks such as the Internet, wired or wireless public telephone networks, wired or wireless LANs, or dedicated lines. The server device 3 is a server that manages and controls transmission of data associated with a questionnaire, count and analysis of responses to the questionnaire, and the like.

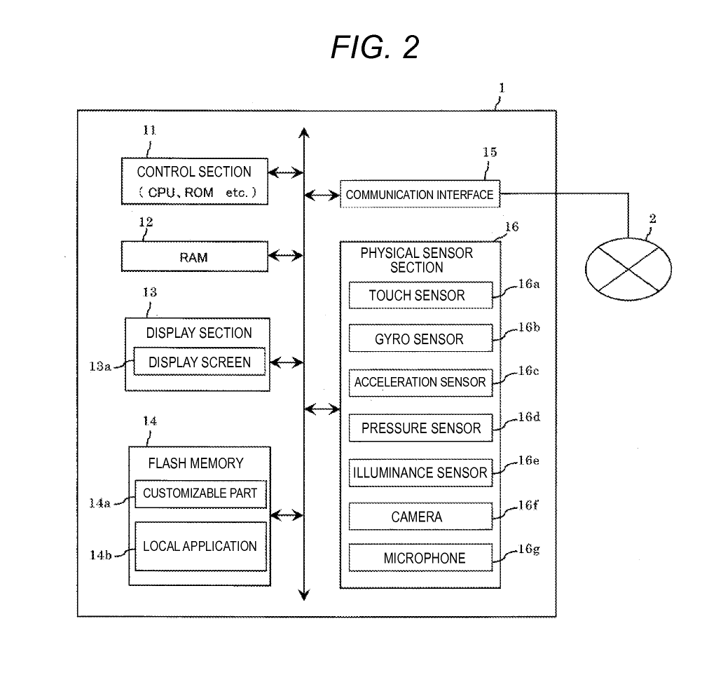

FIG. 2 is a block diagram illustrating a configuration of the questionnaire response device 1 according to the embodiment of the first invention. As illustrated in the drawing, the questionnaire response device 1 includes a control section 11, a RAM 12, a display section 13, a flash memory 14, a communication interface 15, and a physical sensor section 16 and is connected to the communication network 2 via the communication interface 15.

The control section 11 performs control with reference to programs or data stored in a storage device such as the flash memory 14. The RAM 12 is a work area of the control section 11.

The display section 13 includes a display screen 13a on which questions of a questionnaire, response input details, a questionnaire response result, and the like are displayed.

The flash memory 14 is used as a memory area for storing programs or data, and stores a customizable part 14a including at least one type of data selected from a text, an image, a voice, and a video constituting questions of an individual questionnaire survey item which are received from the server device 3 and a local application 14b for processing a physical action result of a respondent on the questionnaire response devices 1 or the like in combination with the customizable part. Parameters which are data input from the physical sensor section 16 by a respondent's operation, response information generated based on the parameters, and the like can also be stored in the flash memory 14.

The customizable part 14a is acquired by causing the questionnaire response devices 1 to acquire a customizable part 33a stored in the server device 3 via the communication network 2 and to store the acquired customizable part in the flash memory 14, and plural customizable parts are prepared for each individual questionnaire survey item. The customizable part 14a constructs an application relevant to a questionnaire response in combination with the local application 14b, details of which will be described later, stored in the questionnaire response devices 1 in advance. This application performs display of questions of an individual questionnaire survey item, acquisition of a parameter input by a respondent's operation, display of questionnaire contents on a display screen based on the response information or the parameter, transmission of response information to the server device 3 of the survey sponsor, and the like. Specific examples of the customizable part 14a include parts including data such as images such as company logo, photographs, and illustrations and a text, a voice, or a video relevant to questionnaire questions, types, characteristics, and layouts of used parts, and part data, such as XML file data, including data in which one of the functions of the local application 33a is used or definition of usage thereof or the like is described.

The local application 14b includes a program that performs various processes such as presentation of questionnaire questions on the display screen 13a, acquisition of a parameter input from the physical sensor section 16 by a respondent's operation, conversion of the acquired parameter into response information, and transmission of the parameter or the response information to the server device 3, which are performed in the questionnaire response devices 1, with reference to data included in the customizable part 14a to be described later. A specific example thereof is a library which includes plural program components so as not to be executed alone. A respondent can acquire the local application 14b by downloading the local application 33b from the server device 3 such as an application market providing applications for smart devices as a server which is accessed to acquire an application to be used in the questionnaire response device 1 and storing the local application in the flash memory 14 of the questionnaire response device 1. After the local application 14b is once acquired, the respondent does not need to acquire the local application 14b again even when the respondent responds to plural questionnaires, and only has to additionally acquire the corresponding customizable part 14a for each individual questionnaire survey item. That is, the local application 14b includes a program group for realizing the functions required in common for plural individual questionnaire survey items. An example of such a program group is a program group for constructing small-sized widgets so as to acquire information for performing a specific function on a screen of a smart device.

The communication interface 15 communicates with the server device 3 via the communication network 2 such as a mobile phone network, a Wi-Fi network, or the Internet.

The physical sensor section 16 includes one or more physical sensors of a touch sensor 16a, a gyro sensor 16b, an acceleration sensor 16c, a pressure sensor 16d, an illuminance sensor 16e, a camera 16f, and a microphone 16g. The touch sensor 16a can sense a touch of a respondent with the questionnaire response device 1 and can detects a touch operation on a questionnaire response display screen which is a touch panel, a button pressing operation, and the like. The gyro sensor 16b can detect an angular velocity and can sense inclination or rotation of the questionnaire response device 1. The acceleration sensor 16c can detect acceleration and can sense a force for moving the questionnaire response device 1 or the like. The pressure sensor 16d can detect a pressure and can monitor an atmospheric pressure or the like or sense pressing on the display screen 13a. The illuminance sensor 16e can detect surrounding illuminance and can adjust luminance of the display screen 13a depending on brightness. The camera 16f is a camera which can capture a still image or a moving image around the questionnaire response device 1 and preferably has, for example, a function of tracking an eye by capturing an eyeball. The microphone 16g is a microphone for collecting sound and preferably has a function of extracting a voiceprint, a sound volume, a pitch, and the like.

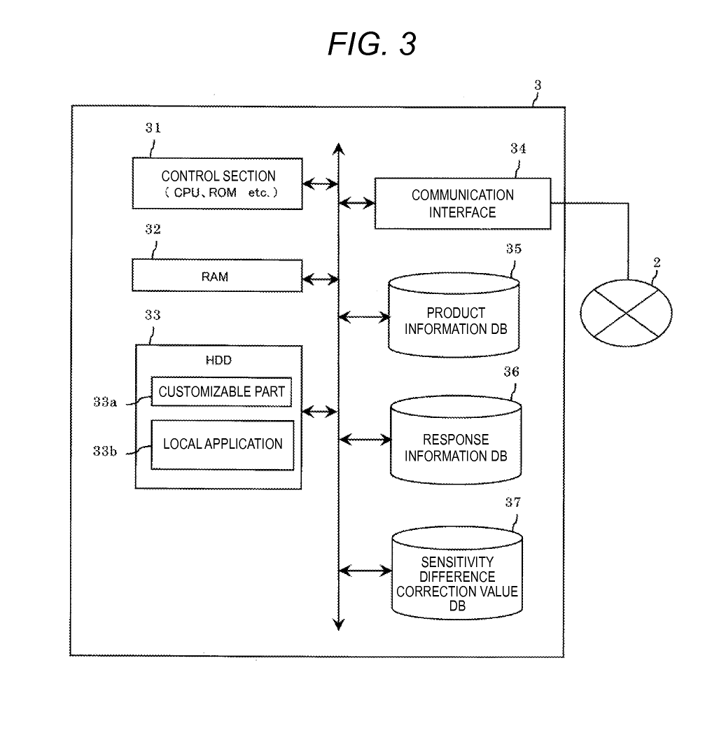

FIG. 3 is a block diagram illustrating a configuration of the server device 3 according to the embodiment of the first invention. As illustrated in the drawing, the server device 3 includes a control section 31, a RAM 32, an HDD 33, a communication interface 34, a product information database 35, a response information database 36, and a sensitivity difference correction value database 37 and is connected to the communication network 2 via the communication interface 34.

The control section 31 performs control with reference to programs or data stored in the storage device such as the HDD 33. The RAM 32 is a work area of the control section 31.

The HDD 33 stores a customizable part 33a including at least one type of data selected from a text, an image, a voice, and a video constituting questions of an individual questionnaire survey item and a local application 33b for processing a physical action result of a respondent on the questionnaire response devices 1 or the like in combination with the customizable part. The HDD may store information such as the parameter or the response information which is transmitted from the questionnaire response device 1 by a respondent's response.

The customizable part 33a is provided from the server device 3 or the like of the survey sponsor, is acquired by the questionnaire response device 1, and is stored as the customizable part 14a in the flash memory 14. Plural customizable parts 33a are prepared to correspond to individual questionnaire survey items. The customizable part 33a may be provided from the same server as providing the local application 33b.

The local application 33b is acquired by the questionnaire response device 1 and is stored as the local application 14b in the flash memory 14, and constructs an application relevant to a questionnaire response in the questionnaire response device 1 in combination with the customizable part 14a. The local application 33b is preferably provided from the server device 3 such as an application market providing applications which operate in a smart device, but may be provided from the server device 3 of the survey sponsor. In a state in which the customizable part 33a is introduced already, the local application may be stored in the server device 3 such as an application market and may be acquired by the questionnaire response device 1 of a respondent. The local application 33b and the customizable part 33a may be acquired from the same server device 3, but the customizable part 33a is preferably transmitted from the server device 3 of the survey sponsor other than an application market for the purpose of reduction of a load in a server such as an application market providing applications.

The product information database 35 stores product information which is data in which fact information of products such as specification information, advertisement information, and sale information of products as a questionnaire survey target are combined with information obtained by quantifying needs of a respondent from information which has been intuitively returned by a respondent using a physical sensor. A product is not limited to a material product, but may be an immaterial product such as a service. When a product is a piece of real estate, examples of product information include information such as “walking time from a station”, “the area of a living room”, and “whether a broadband is built in” which are specification information of a product and data in which information such as “relax life”, “active and exciting life”, “stylish life”, and “safe and stable life” which is information extracted as a respondent's needs by quantifying information intuitively returned from the respondent is combined. The product information database 35 is disposed in the server device 3 that transmits and receives information to and from the questionnaire response device 1, but may be disposed in another server device connectable to the server device 3, for example, the server device of the survey sponsor or the like, and may be configured so as to be referred to by the server device 3.

The response information database 36 stores questionnaire response information transmitted from the questionnaire response device 1, response information corrected by the questionnaire response device 1 and/or the server device 3, or the like.

The sensitivity difference correction value database 37 is a database that stores data used to correct a sensitivity difference of the physical sensor section 16 between the questionnaire response devices 1. The correction of the sensitivity difference is performed, for example, by a method of performing an input operation test for the physical sensor section 16 in advance under the same condition as in other questionnaire response devices 1, calculating a correction value for correcting the sensitivity difference for each questionnaire response device 1 from parameters acquired in the test, and correcting the sensitivity difference between plural questionnaire response devices 1 using the correction value. Specific examples of the input operation test include measurement of a reaction speed until a gyro reaches a specific angle when the questionnaire response device 1 is inclined at the same angle at the same speed and measurement of a sound volume and a waveform of a signal sound emitted at the same decibel and detected by a microphone. The sensitivity difference correction value acquired from the test result is stored in the sensitivity difference correction value database 37.

A specific example of the sensitivity difference correction value is a separation value indicating how a parameter associated with the sensitivity of the physical sensor acquired in a type of questionnaire response device as a test target is separated from an average value of all the questionnaire response devices including other types. The correction method using the sensitivity difference correction value in the first invention is not limited to this example, and any method such as a method of constructing a correction equation for correcting the sensitivity difference between the questionnaire response devices using a maximum value, a minimum value, and an average value of the parameter acquired from the physical sensor in the test and employing the correction equation can be used as long as it can correct the sensitivity differences between other questionnaire response devices.

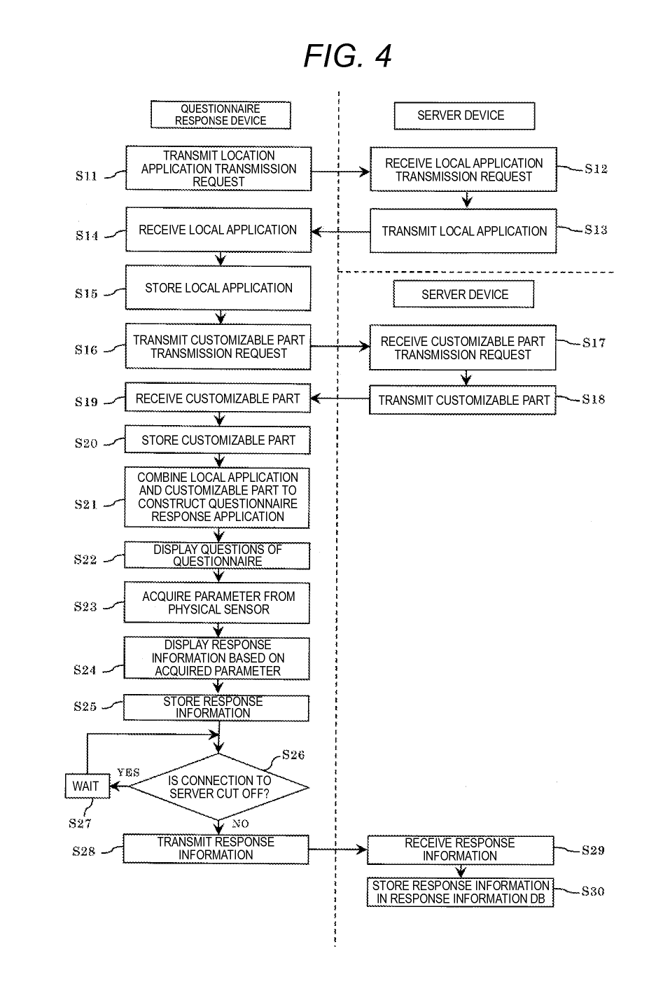

A process of collecting response information to a questionnaire from a respondent will be described below which is performed in the questionnaire system according to the first invention. FIG. 4 is a diagram illustrating a flowchart of the process of collecting response information to a questionnaire from a respondent according to the embodiment of the first invention.

First, a respondent acquires the local application 33b relevant to a questionnaire. The questionnaire response device 1 transmits a transmission request for the local application to the server device 3 such as an application market providing applications for smart devices via the communication network 2 (step S11). The server device 3 receives the transmission request for the local application (step S12) and transmits the local application 33b corresponding to the transmission request to the questionnaire response device 1 (step S13). The questionnaire response device 1 receives the local application 33b (step S14) and stores the received local application as the local application 14b in the flash memory 14 (step S15). The customizable part 33a may be incorporated into the received local application 33b from the first time.

The respondent acquires the customizable part 33a constituting questions of an individual questionnaire survey item. The questionnaire response device 1 transmits a transmission request for a customizable part to the server device 3 of the survey sponsor or the like (step S16). The server device 3 receives the transmission request for a customizable part (step S17) and transmits the customizable part 33a corresponding to the transmission request to the questionnaire response device 1 (step S18). The questionnaire response device 1 receives the customizable part 33a (step S19) and stores the received customizable part as the customizable part 14a in the flash memory 14 (step S20).

Then, the acquired customizable part 14a and the acquired local application 14b are combined to construct a questionnaire response application for performing this questionnaire survey item (step S21). For example, the customizable part 14a includes text data on questions of a questionnaire corresponding to the individual questionnaire survey item, image data such as a background for displaying questionnaire details on the display screen 13a of the questionnaire response device 1 or objects which moves on the display screen by the respondent's operation of the questionnaire response device 1, sensor control data for designating a part of a library of the local application 14b corresponding to a physical sensor used for a respondent's response to the questionnaire and acquiring a parameter sensed by the physical sensor, transmission destination designation data for designating the server device 3 as a transmission destination to which response information as a response result to the questionnaire is transmitted, and command data for instructing to progress the questionnaire as a whole. In order for the library of the local application 14b to perform various processes in response to the instruction using the data, both are combined to construct an application for executing the questionnaire survey item. The constructed application displays questions of the questionnaire on the display screen 13a of the display section 13 of the questionnaire response device 1 (step S22).

The respondent responds to the questions of the questionnaire displayed on the display screen 13a using the questionnaire response device 1. The response of the respondent includes a physical action of the respondent on the questionnaire response device 1 or acquisition of information on outside circumstances of the questionnaire response device 1 using various physical sensors of the physical sensor section 16 by the respondent's operation. Examples of the physical action of the respondent on the questionnaire response device 1 include a shaking action, an inclining action, a rotating action, a holding action, a rubbing action, a stroking action, a slipping action, a tapping action, a looking action, a shading action, a blowing action, and a talking action. Examples of the information on outside circumstances of the questionnaire response device 1, which is acquired from the physical sensors by the respondent's operation, include surrounding illuminance, scenery around the questionnaire response device 1 or behavior of the respondent which is imaged and recorded by the camera, and surrounding sound sensed by the microphone. The parameter which is information acquired from the physical sensor section 16 of the questionnaire response device 1 by the respondent's operation or behavior by the respondent's response (step S23).

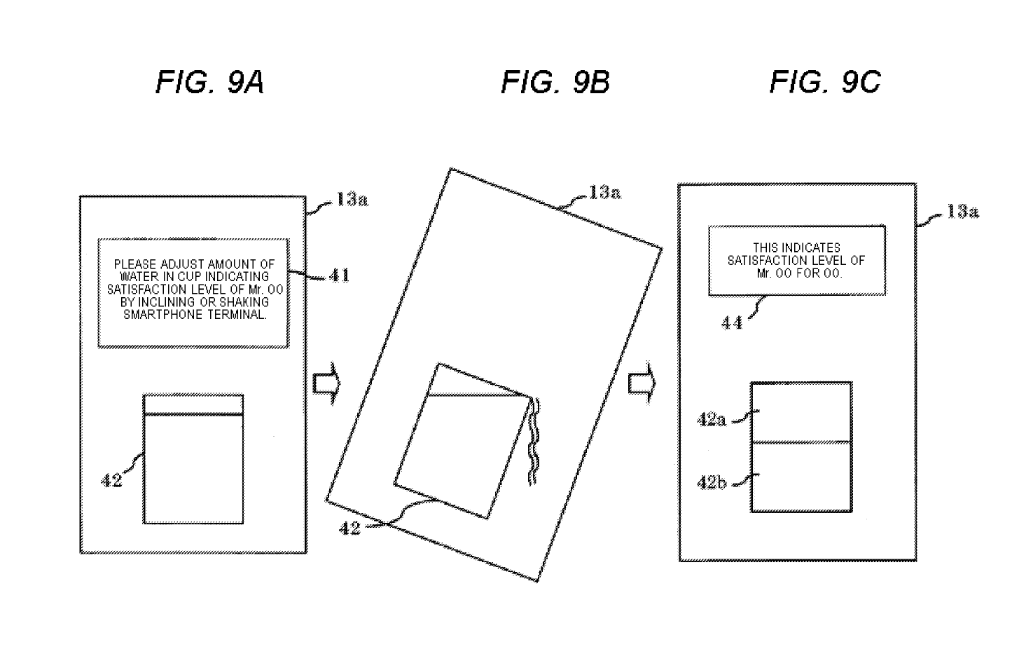

The questionnaire response device 1 displays response information based on the acquired parameter on the display screen 13a of the display section 13 (step S24). For example, as illustrated in FIGS. 9(a) to 9(c), in the questionnaire response application, an amount of water in a cup is used as an indicator indicating a satisfaction level at question details of a questionnaire and the satisfaction level of the respondent at the question details can be returned by inclining the cup displayed on the display screen and appropriately pouring out water in the cup. In this case, when the respondent inclines the questionnaire response device 1, a parameter relevant to the angular velocity of the inclination is generated by the gyro sensor 16b, the inclination angle of the cup or the like is calculated based on the parameter, and an image in which water in the cup on the display screen 13a is poured out is displayed by interlocking the water level with the calculated inclination angle (for example, see FIGS. 9(a) to 9(c)).

When response information is generated by the respondent's operation, the questionnaire response device 1 stores the response information in the storage device such as the flash memory 14 (step S25). Accordingly, the response information can be retained in the questionnaire response device 1. Accordingly, even when the connection between the questionnaire response device 1 and the server device 3 is cut off in the middle of the respondent's response to the questionnaire or at the time of transmitting the response information to the server device 3 after the responding ends, the response information can be transmitted after the connection between the questionnaire response device 1 and the server device 3 is restored.

After the response information is stored in the flash memory 14 in step S25, the questionnaire response device 1 determines whether the connection to the server device 3 is not cut off for a predetermined time (step S26). Here, the predetermined time is a time serving as a reference for determining that the connection to the server device 3 is cut off and can be appropriately set. When it is determined that the connection between the questionnaire response device 1 and the server device 3 is cut off, the questionnaire response device 1 holds transmission of the response information to the server device 3 (step S27) and can wait for restoration of the connection to the server device 3. When the connection is not cut off or when the connection is restored in the waiting in step S27, the questionnaire response device 1 transmits the response information to the server device 3 (step S28).

For example, in case of response to a questionnaire including plural sections, in the questionnaire system in the related art, when the connection to a questionnaire response server is cut off, the collection of the respondent's response is stopped and the respondent has to wait for restoration of the connection to the server. Accordingly, even when the responding progresses up to a certain section, there is a problem in that the responding does not progress to a next section. In some cases, the responding to the questionnaire has to be performed again from the head, which is very troublesome to the respondent.

In the first invention, the response information from the respondent can be stored and the entire information on the questions of the questionnaire is stored in the questionnaire response device 1. Accordingly, even when the connection to the server device 3 is cut off during the responding, the responding can continuously progress to a next section and the responding to the questionnaire can be continuously performed to the end of questions without stop. The response information can be stored in the flash memory 14 or the like, for example, for each section and can be transmitted to the server device 3 when each section ends. When the connection to the server device 3 is cut off in transmitting the response information to the server device 3, the response information can be stored in the flash memory 14 or the like and the questionnaire response information can be appropriately transmitted after restoration of the connection.

When the connection to the server device 3 is cut off even after the responding to the questions of the questionnaire is completed, the questionnaire response application is preferably set so as to end the collection of the questionnaire response from the respondent, to enable the respondent to use other functions of the smart device, and hold transmission of the response information stored in the flash memory 14 or the like from the questionnaire response device 1 in the background. In this case, in order for the questionnaire response application to notify the respondent that the process of transmitting the response information is held, the questionnaire response application is preferably set to display some information, for example, to display a mark or the like indicating that the transmission of the response information is held on an icon of the questionnaire response application on the display screen 13a of the questionnaire response device 1.

The server device 3 receives the response information transmitted from the questionnaire response device 1 (step S29) and stores the received response information in the response information database 36 (step S30). The stored response information is counted along with the response information received and stored from other questionnaire response devices 1 and is subjected to analysis such as statistical processing, data of the questionnaire survey result is generated, and then the data of the survey result is provided to the survey sponsor or the like.

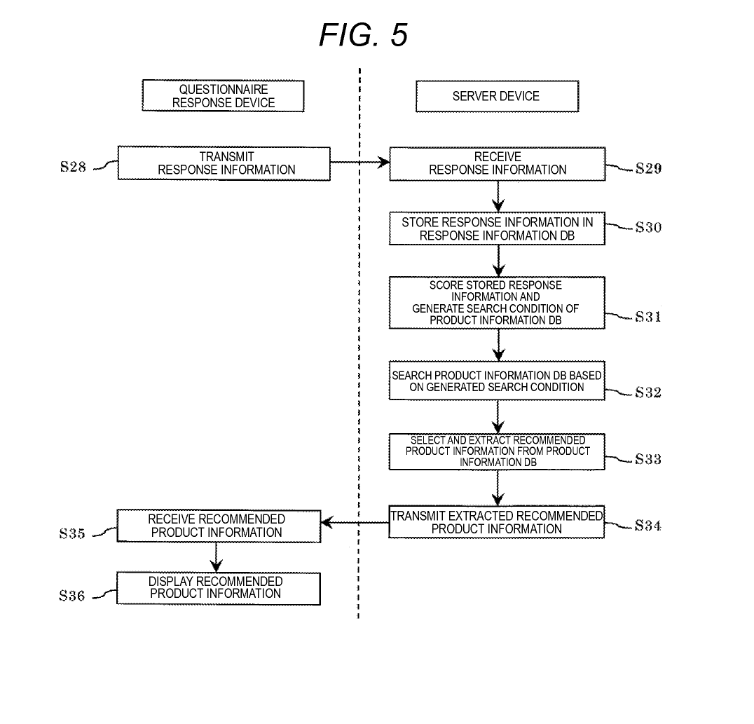

A process of selecting product information to be recommended to a respondent based on a response from the respondent in the questionnaire system according to the first invention will be described below. FIG. 5 is a diagram illustrating a flowchart of the process of selecting recommended product information according to the embodiment of the first invention.

As described above with reference to FIG. 4, the questionnaire response device 1 acquiring and storing the response information from the respondent transmits the response information to the server device 3 (step S28).

The server device 3 receives the response information transmitted from the questionnaire response device 1 (step S29) and stores the received response information in the response information database 36 (step S30).

The server device 3 scores the response information stored in the response information database 36 and generates a search condition for searching for product information to be recommended to the respondent from the product information database 35 (step S31). The scoring of the response information means that the parameter sensed by the physical sensor section 16 in response to the respondent's operation or the like or the response information acquired by performing combination with questionnaire items or a calculation process based on the parameter is converted into significant numerical data.

For example, in a questionnaire about a real estate rental article, when question items having a high abstraction level, such as “relax life” and “active and exciting life”, are provided, a respondent may respond to the question items so as for the respondent to express a degree of importance using an action of shaking the smart device. In this example, the scoring of the response information is performed, for example, by analyzing and calculating data of the parameter or the response information and acquiring numerical data such as the maximum acceleration detected by the acceleration sensor of the smart device, the maximum angular velocity detected by the gyro sensor, and the number of times of shaking the smart device acquired from the variation of the acceleration or the angular velocity.

Accordingly, the response information to the questions of the questionnaire such as the parameter acquired by an intuitive operation such as largely and strongly shaking the smart device or lightly and weakly shaking the smart device can be scored as a numerical value of a continuous variable or the like. Latent thought, sense, tendency, desire, and the like for products of which the respondent has been unaware can be ranked by this scoring, and the latent thought, sense, tendency, desire, and the like which are needs of which the respondent has not been unaware can be visualized by displaying the score on the display screen 13a. By converting the response information into numerical data of a continuous variable or the like, priority levels of plural questions, degrees of priority thereof, or the like can be calculated and extracted as data. Accordingly, a search condition for searching for products to be recommended to the respondent can be generated from the product information database 35 based on this data.

The server device 3 searches for product information to be recommended to the respondent from the product information database 35 based on the generated search condition (step S32), selects and extracts the recommended product information which is acquired by the search and which is product information suitable for recommendation to the respondent (step S33), and transmits the extracted recommended product information to the questionnaire response device 1 (step S34).

An example of the method of searching for product information in step S32 is a method of generating priority values which are values obtained by quantifying the degrees of priority of a respondent on various product specifications presented in questionnaire questions and the priority levels of a respondent on various product specifications as the search condition, coupling products to a virtual pattern of the priority values and the priority levels of respondents suitable for recommending products and storing the coupling result as product information in the product information database 35 in advance, and comparing the virtual pattern with the search condition.

Examples of the method of selecting and extracting recommended product information in step S33 include a method of selecting product information having a virtual pattern closest to the above-mentioned search condition as recommended product information and a method of comparing the priority levels higher than a predetermined priority level included in the search condition with the virtual pattern of the product information and selecting the recommended product information. That is, the method is not particularly limited as long as product information to be suitably recommended to a respondent can be selected from the search condition.

The questionnaire response device 1 receives the recommended product information from the server device 3 (step S35) and displays the received recommended product information on the display screen 13a of the display section 13 (step S36). An example of the displayed recommended product information is article information, for example, in case of recommended product information in a questionnaire about real estate rental articles.

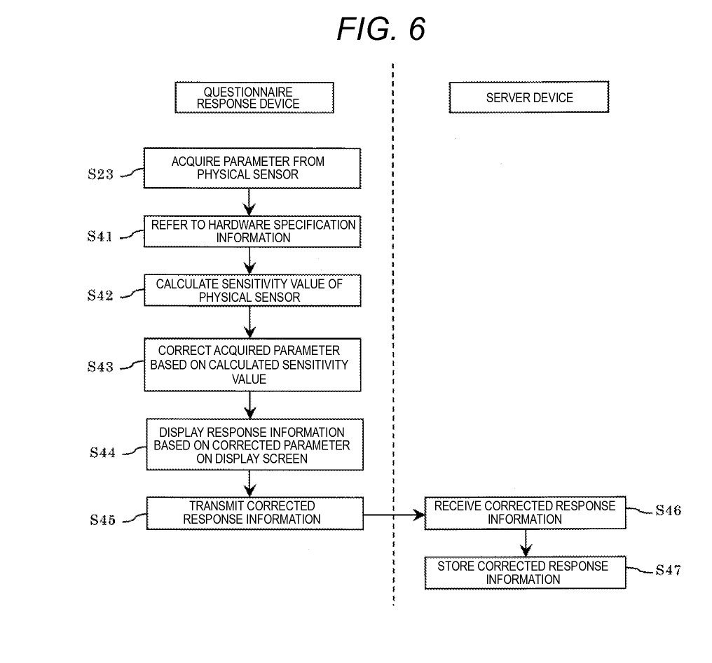

A process of correcting response information on the questionnaire response device side based on the sensitivity difference of a physical sensor between plural questionnaire response devices in the questionnaire system according to the first invention will be described below. FIG. 6 is a diagram illustrating a flowchart of a process of correcting response information based on the sensitivity difference between physical sensors on the questionnaire response device side according to the embodiment of the first invention.

As illustrated in FIG. 4, the questionnaire response device 1 acquires a parameter indicating a physical action of a respondent on the questionnaire response device and/or outside circumstances of the questionnaire response device 1 using the physical sensor section 16 (step S23). Here, the questionnaire response device 1 calculates the sensitivity value of the physical sensor section 16 (step S42) with reference to specification information of its hardware specification (step S41).

The specification information of the hardware specification is information on the hardware specification of the questionnaire response device 1 which can affect the response information acquired by the respondent's operation. Examples thereof include model information including the type or performance of a CPU and capacity of a mounted RAM which can affect responsiveness to display contents on the questionnaire response screen, model numbers of various sensors of the physical sensor section, and information such as dynamic ranges, maximum/minimum detection sensitivities, and temporal resolutions, which can be detected, of the sensors.

The specification information is stored in the storage device such as the flash memory 14 of the questionnaire response device 1 in advance, and may be information acquired by an operating system or the like activating the questionnaire response device 1 with reference to itself or may be acquired from the outside such as the server device 3 in advance. The specification information may be specification information specific to model groups to which smart devices of respondents belong or may be specification information specific to a smart device which is used in this questionnaire.

As an example of the method of calculating the sensitivity value, a method of calculating a dynamic range using a detection upper limit and a detection lower limit which are specifications of a physical sensor included in a smart device and setting the dynamic range as the sensitivity value and a method of calculating a difference in detected value of the physical sensors between the smart device and other smart devices as the sensitivity value using an expression for calculating a delay of a detection timing of the physical sensor from the model information or the like can be used.

The questionnaire response device 1 corrects the parameter acquired from the physical sensor section 16 based on the calculated sensitivity value (step S43). An example of the method of correcting the parameter is a method of using average values of the upper limits and the lower limits of the dynamic ranges of all models of smart devices used for the questionnaire response as a reference and matching the acquired parameter with this reference when the calculated sensitivity value is relevant to the detection upper limit and the detection lower limit of the dynamic range. Specifically, in order to match the detection upper limit and the detection lower limit included in the sensitivity value of the questionnaire response device 1 with the average values, the parameter sensed in the questionnaire response device 1 can be corrected and standardized using a method using a regression equation which is derived from the sensitivity value, a method of calculating the difference between the sensitivity value and the average value and performing addition/ subtraction or multiplication on the parameter value, or the like. The first invention is not limited to these examples, and another method may be used as long as the method is a correction method capable of standardizing a difference of the parameter detected by the physical sensors and resulting from the hardware specification difference between the individual smart devices using the sensitivity value calculated from the specification information.

The questionnaire response device 1 displays the response information based on the parameter corrected in step S43 on the display screen 13a (step S44) and transmits the corrected response information to the server device 3 (step S45).

The server device 3 receives the corrected response information transmitted from the questionnaire response device 1 (step S46) and stores the corrected response information in the response information database 36 (step S47). The response information stored in the response information database 36 is counted along with the response information received and stored from other questionnaire response devices 1 and is subjected to analysis such as statistical processing, data of the questionnaire survey result is generated, and then the data of the survey result is provided to the survey sponsor or the like.

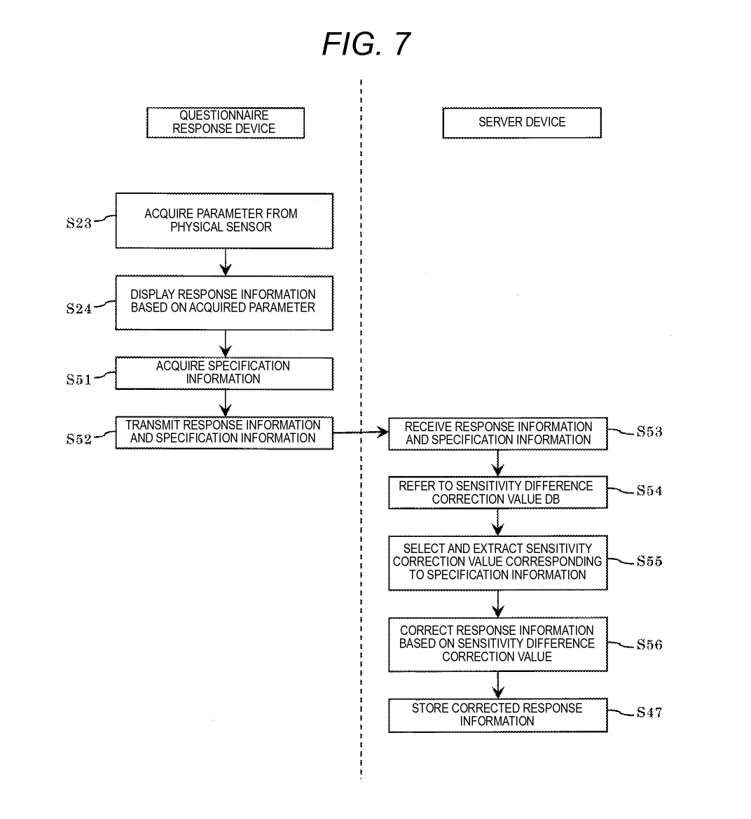

A process of correcting response information to a questionnaire based on a sensitivity difference by the physical sensors on the server device side in the questionnaire system according to the first invention will be described below. FIG. 7 is a diagram illustrating a flowchart of a process of correcting response information to a questionnaire based on a sensitivity difference by physical sensors on the server device side according to the embodiment of the first invention.

As described above in detail with reference to FIG. 4, the questionnaire response device 1 acquires a parameter indicating a physical action of a respondent on the questionnaire response device and/or outside circumstances of the questionnaire response device using the physical sensor section 16 (step S23) and displays response information based on the acquired parameter on the display screen 13a of the display section 13 (step S24).

Then, the questionnaire response device 1 acquires the specification information of the questionnaire response device 1 (step S51) and transmits the response information and the acquired specification information to the server device 3 (step S52). Examples of the specification information include specification information on the hardware specification of a smart device, which can enable distinguishing the smart device from the type of smart devices, such as model information or a production serial number of the smart device used by the respondent.

The server device 3 receives the response information and the specification information (step S53), and selects and extracts the sensitivity difference correction value corresponding to the questionnaire response device 1 specified by the specification information (step S55) with reference to the sensitivity difference correction value database 37 based on the received specification information (step S54). The sensitivity difference correction value represents what difference occurs between the parameters acquired from the physical sensor section s 16 when the same operation is performed on plural questionnaire response devices 1, and is data which enables comparing the response information or analysis data acquired from plural pieces of response information more accurately mutually by standardizing response information from the plural questionnaire response devices 1.

Regarding the sensitivity difference correction value, a pre-test is performed to calculate the sensitivity difference correction values of various smart devices, the sensitivity difference correction values are calculated for models or lots, and the sensitivity difference correction values of various smart devices are stored in the sensitivity difference correction value database 37 of the server device 3 in advance.

Specific examples of the sensitivity difference correction value include a coefficient or a regression equation for standardizing the sensitivity difference between the physical sensors using the specification difference in the hardware specification between the smart devices. A specific example of the coefficient is a separation value between a parameter value sensed by a physical sensor and included in response information from the questionnaire response device 1 regarding the same predetermined operation and an average value of parameter values sensed by physical sensors of all smartphones of a model which is tested in advance. In this case, corrected response information can be acquired by adding or subtracting the separation value stored in the sensitivity difference correction value database 37 to or from the parameter value acquired in the questionnaire response device 1. Examples of a case in which the sensitivity difference correction value is a regression equation include a case in which the value of the parameter is converted using the regression equation and the differences in input and output characteristics are standardized in order to match a curve indicating the input and output characteristics with a predetermined reference curve when the input and output characteristics of the value of the parameter acquired from the physical sensor section 16 differ between plural models of questionnaire response devices 1.

The server device 3 corrects the response information based on the sensitivity difference correction value (step S56) and stores the corrected response information in the response information database 36 (step S47). As described above, the correction of the response information is performed based on the sensitivity difference correction value such as the coefficient or the regression equation stored in the sensitivity difference correction value database 37. Accordingly, it is possible to standardize the differences in the parameter value sensed by the physical sensor section 16 or the differences in the response information which are based on the specification differences in the hardware specification between plural questionnaire response devices 1.

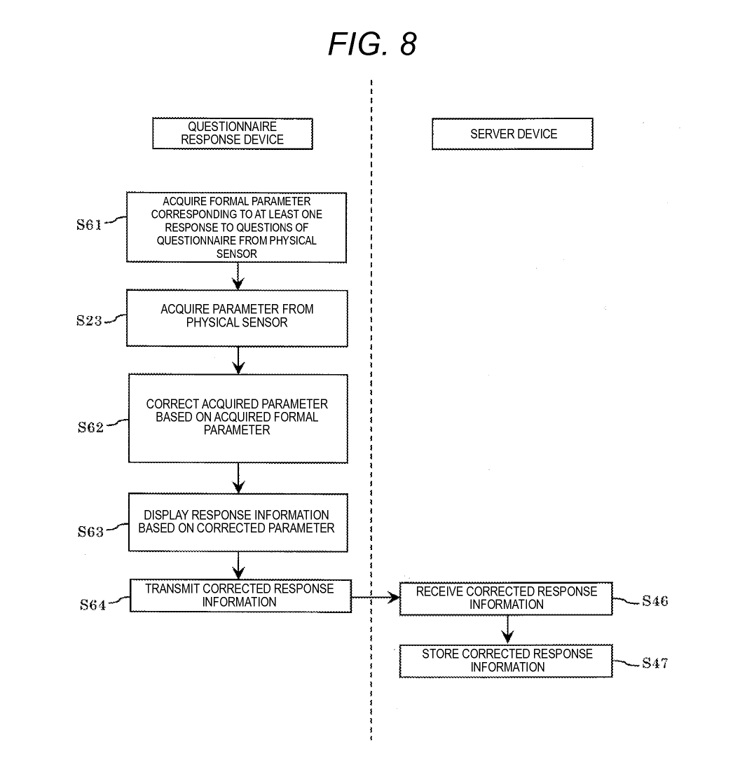

In the questionnaire system according to the first invention, a process of causing a respondent to operate the questionnaire response device 1 in a responding exercise, acquiring a formal parameter at this time, and correcting response information in main responding based on the formal parameter on the questionnaire response device side will be described below. FIG. 8 is a diagram illustrating a flowchart of the process of correcting response information based on a formal parameter on the questionnaire response device side according to the embodiment of the first invention.

First, a message indicating that a responding exercise is carried out and questions of a questionnaire for a responding exercise are displayed on the display screen 13a of the questionnaire response device 1. Accordingly, a respondent operates the questionnaire response device 1. By this operation, the questionnaire response device 1 acquires a formal parameter corresponding to a response to the questions of the questionnaire from the physical sensor section 16 (step S61). The acquisition of the formal parameter is preferably performed plural times, but may be performed one time.

For example, when a respondent responds to a question of a questionnaire about convenience of a real estate rental article by a degree of importance of a certain question item, the respondent can intuitively return the degree of importance by strongly shaking or weakly shaking the smart device. However, even when the respondent recognizes the same degree of importance about plural question items, there is a possibility that the response information including different degrees of importance about the question items will be generated due to a difference in the action of the respondent shaking the smart device, a sensitivity difference of the physical sensors of the smart device, or the like. Accordingly, in order to correct the parameter acquired from the physical sensor to generate corrected response information, the responding exercise is carried out and response information acquired in main responding is corrected based on the formal parameter acquired in the responding exercise to acquire corrected response information as a correct result. In an example of the method of acquiring the formal parameter in the responding exercise, a detection upper limit or a detection lower limit of the parameter detected by a physical sensor of the smart device can be acquired as the formal parameter by causing the respondent to shake the smart device to correspond to a maximum value or a minimum value of a degree of importance about a question item.

After the formal parameter is acquired, as illustrated in FIG. 4, the questionnaire response device 1 acquires the parameter indicating a physical action of the respondent on the questionnaire response device and/or outside circumstances of the questionnaire response device from the physical sensor (step S23).

Then, the questionnaire response device 1 corrects the parameter acquired in the main responding based on the formal parameter acquired in step S23 (step S62). The correction of the parameter is performed based on the formal parameter using methods such as the above-mentioned correction method using a sensitivity value or the above-mentioned correction method using a sensitivity difference correction value. Thereafter, the questionnaire response device 1 generates and displays response information based on the corrected parameter (step S63) and transmits the corrected response information (step S64).

As described above with reference to FIG. 4, the server device 3 receives the corrected response information transmitted from the questionnaire response device 1 (step S46) and stores the corrected response information in the response information database 36 (step S47).

After the response information is transmitted from the questionnaire response device 1 to the server device 3 in step S28, step S45, step S52, step S64, and the like or after the response information transmitted from the questionnaire response device 1 is received by the server device 3 in step S29, step S46, step S53, and the like, it is preferable that the customizable part 14a, which is stored in the questionnaire response device 1, corresponding to the questionnaire survey be automatically deleted. By employing this configuration, since the information on the questions of the questionnaire can be prevented from being opened to persons other than the respondent, the survey sponsor can perform the questionnaire survey in security from the viewpoint of information security or confidentiality. Since the customizable part 14a corresponding to the questionnaire is deleted after responding to the questionnaire survey and thus memory capacity of the smart device is not unnecessarily occupied, a respondent can easily participate in questionnaire surveys which are performed by the questionnaire system according to the first invention.

A first screen example of a response screen to a questionnaire in the questionnaire system according to the first invention will be described below. FIGS. 9(a) to 9(c) are diagrams illustrating an example of the response screen to a questionnaire according to the embodiment of the first invention.

FIG. 9(a) illustrates an example of a screen display which is displayed on the display screen 13a of the display section 13 of the questionnaire response device 1 in a questionnaire which is provided to a respondent with a satisfaction level about a certain product as a question. A question message for a respondent such as “please incline or shake a smartphone terminal to adjust an amount of liquid in a cut indicating your satisfaction level” is displayed on a question window 41 on the display screen 13a. As display details in a responding method from a respondent, a cup 42 filled with a liquid is displayed on the display screen 13a. By inclining the questionnaire response device 1, the respondent can incline the cup 42 to pour out water therein, and the satisfaction level of the respondent about a certain product is expressed by the amount of liquid remaining in the cup. Since the display screen 13a is formed of a touch panel including a touch sensor 16a, the cup can be fully filled with a liquid by tapping the cup 42.

When the respondent inclines or shakes the smart device as the questionnaire response device 1, the liquid in the cup can be poured out as illustrated in FIG. 9(b). Regarding the amount of liquid remaining as the pouring result, a liquid portion 42b and an empty portion 42a are displayed to confirm the satisfaction level about the product by returning the inclination of the smart device as illustrated in FIG. 9(c). In this way, the display of the cup 42 on the response screen is interlocked with the respondent's operation.

After the respondent adjusts the satisfaction level about the product, a check message for the respondent such as “this indicates your satisfaction level about 00” is displayed in a response result window 44. The respondent checks the display details and determines the response result, for example, by tapping the response result window 44 when the response result is correct.

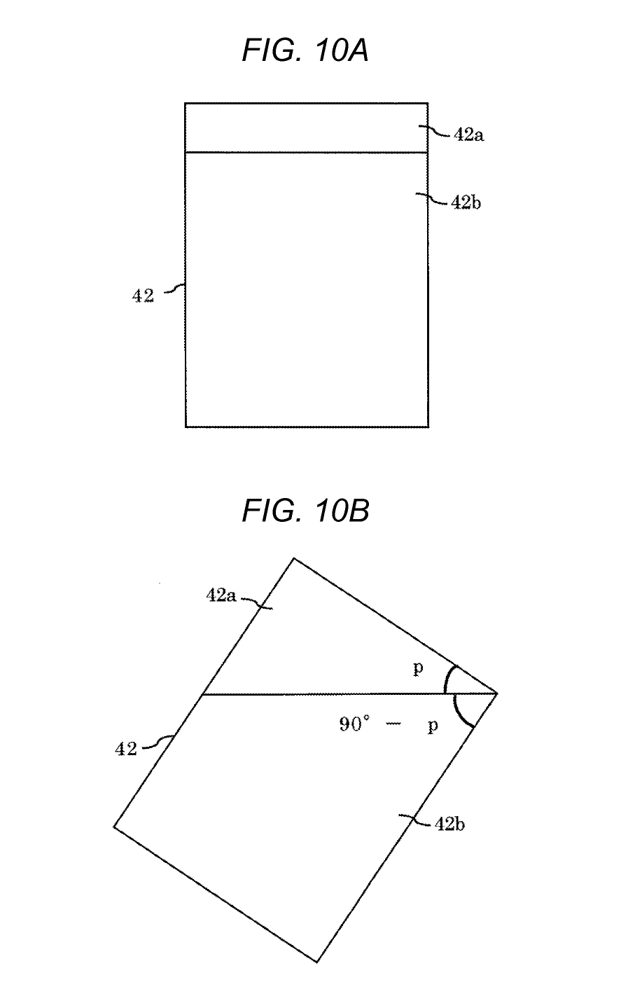

A method of acquiring a parameter from a physical sensor in the questionnaire system according to the first invention will be described below. FIGS. 10(a) and 10(b) are diagrams illustrating an example of the method of acquiring a parameter from a physical sensor according to the embodiment of the first invention.

The method of acquiring a parameter in the questionnaire illustrated in FIGS. 9(a) to 9(c) will be described below with reference to FIGS. 10(a) and 10(b). In this questionnaire, first, a cup 42 as illustrated in FIG. 10(a) is displayed on the display screen 13a as an initial state. A liquid portion 42b and an empty portion 42a appear in the cup 42, an amount of liquid in the initial state, that is, the area of the liquid portion 42b on the display screen 13a or the volume of the liquid portion 42b in a virtual space, indicates a satisfaction level of 100%. When the smart device is inclined, the cup 42 is inclined by interlocking with the inclination or the inclining force and a state in which the liquid in the cup is poured out as illustrated in FIG. 9(b) is displayed on the display screen 13a.

As illustrated in FIG. 10(b), an inclination angle p which is an angle by which the cup 42 is inclined is calculated from a variation of the angular velocity detected by the gyro sensor 16b. The area or the volume of the liquid portion 42b remaining in the cup 42 can be calculated based on the maximum inclination angle p in the history of the inclination angle p which has been calculated using the parameter detected by the gyro sensor 16b. In order to reflect a case in which an action of strongly pouring out the liquid is executed, a certain increment, for example, in a range of 1% to 5% of the inclination angle p may be added to the inclination angle p depending on the value of acceleration which is a parameter detected by the acceleration sensor 16c and which is information on the force for inclining the cup 42 at the inclination angle p calculated by the gyro sensor 16b.

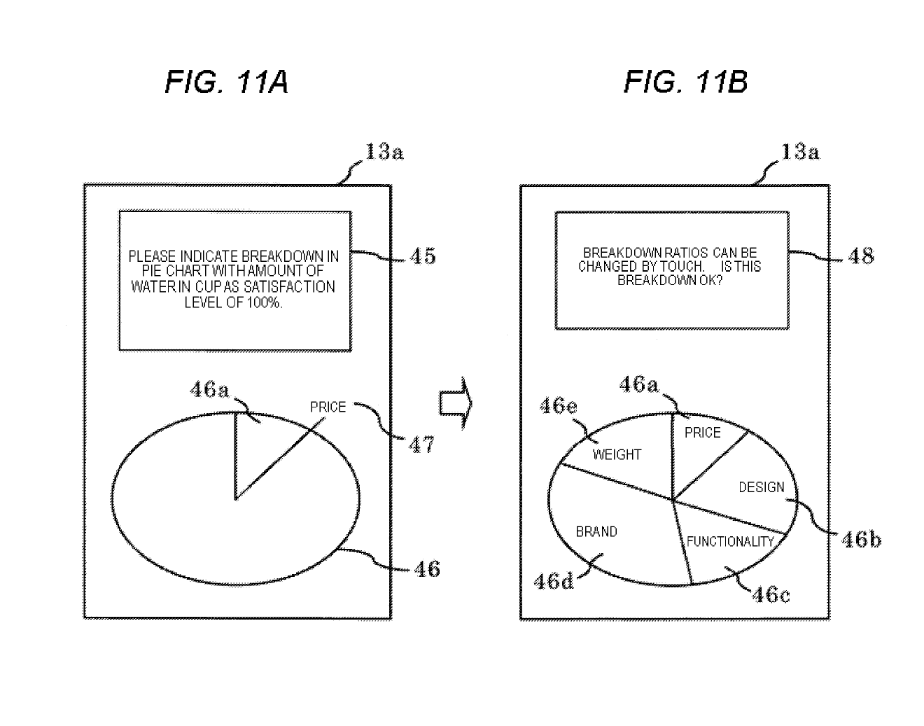

A second screen example of the response screen to a questionnaire in the questionnaire system according to the first invention will be described below. FIGS. 11(a) and 11(b) are diagrams illustrating an example of a response screen to a questionnaire according to the embodiment of the first invention.

In the screen illustrated in FIG. 9(c), when the response result window 44 is tapped to determine the response result, as a continuation of the questionnaire expressing a satisfaction level about a certain product, a question for asking the breakdown of the satisfaction level for the respondent is displayed on the display screen 13a as illustrated in FIG. 11(a). In a question display window 45, a message relevant to a question of the questionnaire such as “please express items of the satisfaction level in a pie chart with the amount of water in the cup as a satisfaction level as 100%” is displayed. In addition to the display of this message, a pie chart 46 is displayed on the display screen 13a and item names 47 indicating the items of the satisfaction level are displayed therein.

The respondent can change the size of an area 46a indicating the ratio of the item name 47 to the entire satisfaction level by touching and dragging the item name 47. The respondent can determine the size of the area 46a by tapping the item name 47 or the like. Before and after the determination, the size of the area 46a may be changed in response to the respondent's operation such as a gesture of changing a gap between two fingers with the two fingers touching an area in the area 46a.

When areas 46a to 46e corresponding to the items are similarly determined for all the items prepared in the questionnaire, details illustrated in FIG. 11(b) are displayed on the display screen 13a. When the respondent taps a completion determination window 48 on this screen, the questionnaire ends.

An example in which the camera is used for a response to a questionnaire in the questionnaire system according to the first invention will be described below.

Information to which a respondent turns eyes, such as a video or an image, is displayed on the display screen 13a of the display section 13 of the questionnaire response device 1. Regarding the display of a video or an image, eye information on where the respondent turns eyes is detected using the camera 16f, the detected eye information is acquired as a parameter, and response information is generated based on the parameter and is transmitted to the server device 3.

A method of detecting eye information will be described below. The camera 16f is disposed on the same side as the display screen 13a of the smart device so as to image a respondent watching the display screen. The camera 16f recognizes the respondent's face, recognizes the position of eyes, and detects where the respondent turns eyes on the display screen 13a from movement of pupils of the eyes. The detected eye information is acquired as a parameter acquired from the camera 16f by questionnaire response device 1. Coordinate data indicating the position on the display screen 13a to which eyes are turned, time information indicating the timing thereof, and the like are acquired as response information based on the parameter.

The server device 3 receives and analyzes the response information acquired in this way and can provide information of the questionnaire result to the survey sponsor. The information of the questionnaire result obtained by analyzing the response information includes information such as a product first attracting the respondent's eyes, the order of products on which eyes stay, and the time in which the eyes stay. By analyzing the information, the survey sponsor can verify consumers' reaction to a color, a design, a shape, and the like of the product in the form for comparison with other products.

A product on which the respondent's eyes stay for a long time, a product which first attracts the respondent's eyes, a product on which the eyes finally stay after the eyes are turned to the products, and the like may be determined as products to be recommended to the respondent, and product information on the products may be transmitted to the questionnaire response device 1 to promote the respondent to buy the products.

An example in which a microphone is used for a response to a questionnaire in the questionnaire system according to the first invention will be described below.

The questionnaire response device 1 is provided with the microphone 16g. On the questionnaire response screen, a message such as “please say “good!” to the microphone with a most pleasant feeling” is displayed as a question of a first training response. When a voice “good!” is uttered by the respondent while the message is displayed, the microphone 16g senses the voice and a first formal parameter is acquired. Then, on the questionnaire response screen, a message such as “please say “good!” to the microphone with a most unpleasant feeling” is displayed as a question of a second training response. When a voice “good!” is uttered by the respondent while the message is displayed, the microphone 16g senses the voice and a second formal parameter is acquired. When a voice from a respondent is sensed, various graphs indicating a sound volume, a pitch, a frequency component, and a voiceprint are displayed on the display screen 13a and the respondent can watch the graphs.

The formal parameters acquired herein include information such as a sound volume, a sound pitch, a frequency component, and a speed of the respondent's voice. The questionnaire response device 1 specifies information serving as an index indicating the respondent's favor from the information included in the first and second formal parameters and generates reference data for converting a degree of favor of the respondent into quantitative data.

A specific example of the index indicating the respondent's favor is an index indicating that the respondent utters a voice with a greater favor as the sound volume is larger, the sound pitch is higher, and the vocal speed is faster. However, the index indicating the respondent's favor is not limited to this index, and another index may be used as long as it is an index indicating a degree of favor of the respondent.

An example of the method of converting the degree of favor of a respondent into quantitative data is a method of determining a maximum value and a minimum value of the first and second formal parameters as reference data and then quantifying the degree of favor indicated by the parameter acquired from the microphone 16g in a numerical value in a range of 0% to 100%.

The parameter acquired in the main responding of the respondent can be corrected based on the reference data generated from the first and second formal parameters to acquire response information. At this time, as display details on the display screen 13a, for example, an image or a video representing products as a questionnaire survey target is displayed and the message “please say “good!” to the microphone with a most pleasant feeling for this product” is displayed. Similar to the training response, when a voice “good!” is uttered by the respondent and is sensed by the microphone 16g, various graphs indicating information on the voice are displayed on the display screen 13a and the respondent can watch the response result.

In this way, by sensing a voice with a favor for a product using the microphone 16g, it is possible to quantify a respondent's abstract likes and dislikes of the product. Accordingly, a respondent can respond to a questionnaire by only uttering a voice and can visualize and recognize a degree of favor for a product which has not been clearly recognized by the respondent. Since information on the voice of the respondent is displayed on the display voice at the time of responding, it is possible to provide the respondent with a method of responding to a questionnaire survey having intuitive and enjoyable elements.

An example in which a pressure sensor is used for a response to a questionnaire in the questionnaire system according to the first invention will be described below.

The questionnaire response device 1 is provided with the pressure sensor 16d. The pressure sensor 16d may sense pressing of a panel disposed in a touch panel or the like or may sense an atmospheric pressure around the smart device.

For example, when the pressure sensor 16d senses pressing on a touch panel or the like, contents such as a moving image or a still image about questionnaire questions such as a CM, a television advertisement, or a movie about products as a questionnaire survey target and a voice about questionnaire questions such as a radio CM are displayed on the questionnaire response screen, and button A which should be pressed when a respondent likes the contents, button B which is pressed when the respondent dislikes the contents, and the like should be displayed on the touch panel. For example, a message “please press button A when you likes this video and press button B when you dislikes this video, depending on a degree of feeling” is displayed as a questionnaire question message. When the pressing on the button by the respondent is sensed by the pressure sensor 16d, various graphs indicating information on the pressing are displayed on the display screen 13a and the respondent can watch the response result.

In this way, by causing a respondent to watch, read, and listen to contents about questionnaire questions for products or the like and sensing a degree of pressing on the touch panel, pressing of a button, or the like as a favor for the contents using the pressure sensor 16d, it is possible to quantify a respondent's abstract likes and dislikes of a product, a CM, a person, a movie, or the like in a numerical value varying with the lapse of time. Accordingly, a respondent can respond to a questionnaire survey by only pressing the touch panel and can visualize and recognize a degree of favor for a product, a CM, a person, a movie, and the like which has not been clearly recognized by the respondent. Since information on the respondent's likes and dislikes of contents such as the degree of pressing by the respondent is displayed on the display screen at the time of responding, it is possible to provide the respondent with a method of responding to a questionnaire survey having intuitive and enjoyable elements. The survey sponsor can also obtain detailed information on respondents' likes and dislikes of contents which vary in real time.

The first invention is not limited to the above-mentioned specific examples, and for example, plural buttons expressing various feelings of a respondent in response to pressing may be provided and a temporal variation in the pressing on the buttons may be acquired as response information.

An example in which an illuminance sensor is used for a response to a questionnaire in the questionnaire system according to the first invention will be described below.

The questionnaire response device 1 is provided with the illuminance sensor 16e. On the questionnaire response screen, a message “please expose the smartphone to a bright place while watching a brightness sensor section” is displayed as a question of the first training response. When the smart device is exposed to a bright place by the respondent while the message is displayed, the illuminance sensor 16e senses the exposure and a first formal parameter is acquired. Then, on the questionnaire response screen, a message such as “please completely shade a brightness sensor section” is displayed as a question of a second training response. When the illuminance sensor is shaded with a hand while the message is displayed, the illuminance sensor 16e senses the shading and a second formal parameter is acquired. In this operation, a graph and the like indicating the illuminance sensed by the illuminance sensor in the environment are displayed on the display screen 13a and the respondent can watch the graph.

The formal parameters acquired herein include information such as a maximum value and a minimum value of illuminance in the environment in which a respondent responds. The questionnaire response device 1 generates reference data for converting a degree of favor of the respondent into quantitative data.

An example of the method of converting the degree of favor of a respondent into quantitative data is a method of determining a maximum value and a minimum value of the first and second formal parameters as reference data and then quantifying the degree of favor indicated by the parameter acquired from the illuminance sensor 16e in a numerical value in a range of 0% to 100%.

The parameter acquired in the main responding of the respondent can be corrected based on the reference data generated from the first and second formal parameters to acquire response information. At this time, as display details on the display screen 13a, for example, an image or a video representing products as a questionnaire survey target is displayed and the message “please expose the brightness sensor to much light when you likes this product and shade the brightness sensor from light with a hand when you dislikes this product” is displayed. Similarly to the training responding, when the surrounding brightness adjusted by the respondent is sensed by the illuminance sensor 16e, various graphs indicating information on the brightness at that time are displayed on the display screen 13a and the respondent can watch the response result.

In this way, by causing a respondent to express a favor for a product with brightness and sensing the brightness using the illuminance sensor 16e, it is possible to quantify a respondent's abstract likes and dislikes of the product. Accordingly, a respondent can respond to a questionnaire by only performing a simple operation and can visualize and recognize a degree of favor for a product which has not been clearly recognized by the respondent. Since information on the brightness sensed by the illuminance sensor based on the respondent's operation is displayed on the display screen at the time of responding, it is possible to provide the respondent with a method of responding to a questionnaire survey having intuitive and enjoyable elements.

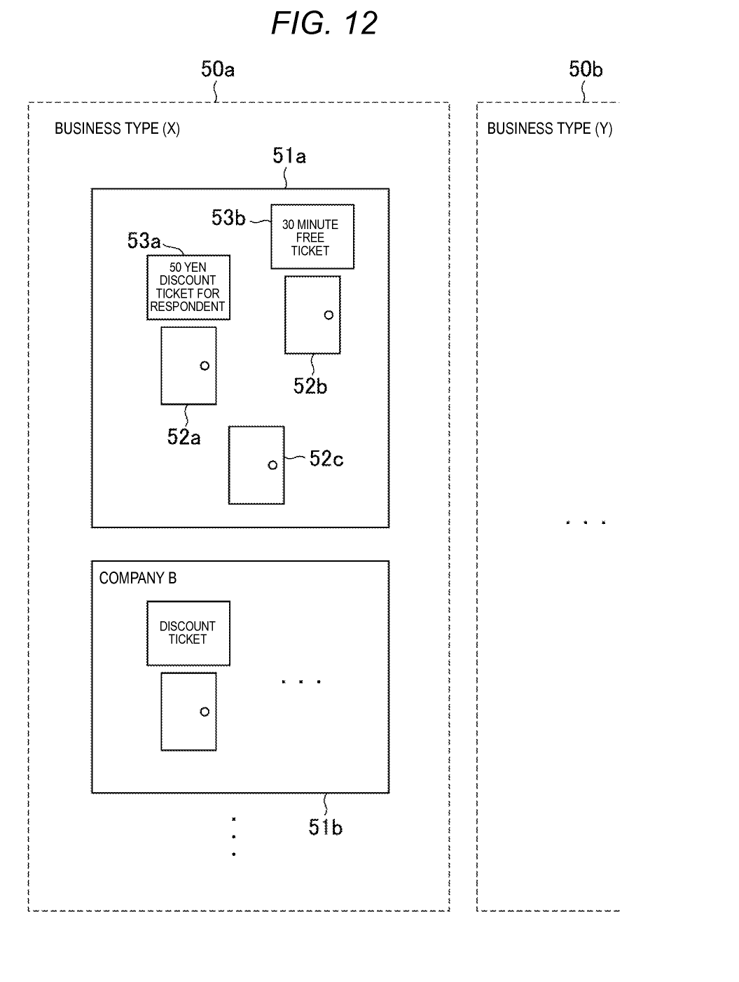

An embodiment of a second invention will be described below with reference to the accompanying drawings. FIG. 12 is a diagram illustrating the concept of a questionnaire survey item in a system according to an embodiment of the second invention. A system operation company that performs management and operation of a server device in a questionnaire system and setting, maintenance, supporting of a client device provides an environment required for a questionnaire survey and a questionnaire response (hereinafter, referred to as a questionnaire environment). In order to response to a questionnaire, a respondent to the questionnaire only has to have a questionnaire response device that can be connected to the questionnaire environment. Examples of the questionnaire response device include a computer terminal, a mobile phone terminal, a tablet terminal, and a terminal dedicated for a questionnaire response and may include an application for a questionnaire response built in various terminals.

The questionnaire environment includes plural business types 50 such as business type (X) 50a, business type (Y) 50b, . . . . Examples of the business type include restaurant business, manufacturing business, and finance and insurance business. Each business type 50 includes plural companies 51 such as company A, company B, . . . . For example, when business type (X) 50a is restaurant business, examples of the company include a restaurant, a bar, and a Japanese restaurant.

Each company 51 includes plural questionnaire survey items such as questionnaire survey items 52a, 52b, . . . . The questionnaire survey item 52a, 52b, . . . display corresponding privilege information 53a, 53b, . . . . The privilege information means rights to acquire coupons such as prices reduction, discount, sample exchange, and point increase and courtesy information such as time-limited sales when a respondent responds to a questionnaire.

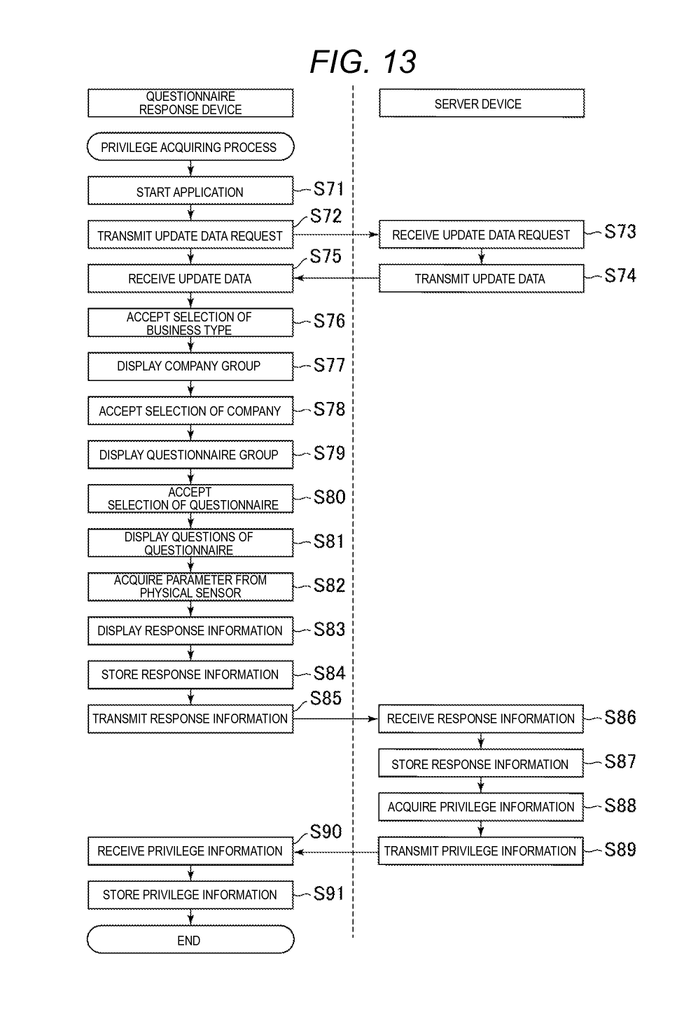

A process of acquiring privilege information by causing a respondent to respond to a questionnaire will be described below. FIG. 13 is a diagram illustrating a flowchart of a process of causing a respondent to acquire privilege information in the system according to the embodiment of the second invention.

First, a respondent starts an application for responding to a questionnaire in the questionnaire response device 1 (step S71). The application may be a dedicated program or may use a browser. When the application is started, the application transmits an update data request to the server device 3 for the purpose of acquiring update data (step S72). The server device 3 receives the update data request (step S73) and transmits the update data to the questionnaire response device 1 (step S74). The questionnaire response device 1 receives the update data (step S75), synchronizes the update data with data of the server device 3, and displays an initial screen after being started.

The respondent selects a business type strongly attracting an interest from the display initial screen (step S76). Here, the business type strongly attracting an interest is not limited to only a business type to which a business type or a company in which the respondent has a strong interest belongs, and a business type in which the respondent has a weak interest may become a business type strongly attracting an interest for the purpose of acquisition of a privilege.

The questionnaire response device 1 displays a company group included in the selected business type (step S77). The respondent selects one company strongly attracting an interest from the displayed company group (step S78). The questionnaire response device 1 displays a questionnaire group provided by the selected company on the display screen (step S79). Here, the company in which the respondent has a strong interest may be registered in a favorite list.

The respondent selects a questionnaire to respond to from the display questionnaire group (step S80). The respondent can check privilege information to be acquired by a response at the time of selecting the questionnaire. The questionnaire response device 1 displays questions of the selected questionnaire survey item (step S81). The processes of steps S81 to S84 correspond to the processes of steps S22 to S25.

The privilege information which is acquired by responding to a questionnaire may provide a privilege of a product of the company providing the questionnaire or may provide a privilege of a product of another company. For example, a company of manufacturing business may provide a questionnaire but may have a difficulty in providing a privilege. In this case, it is possible to provide an incentive for a response to a questionnaire, for example, by providing a price-cutting ticket of a restaurant or a discount ticket of an electronic retail store.

The questionnaire response device 1 storing the response information transmits the response information to the server device 3 (step S85). The server device 3 receives the response information (step S86) and stores the received response information (step S87). The server device 3 identifies the questionnaire to which the respondent has responded from the stored response information and extracts the privilege information corresponding to the questionnaire (step S88). The server device 3 transmits the extracted privilege information to the questionnaire response device (step S89). The questionnaire response device 1 receives the privilege information (step S90) and stores the received privilege information in the storage device (step S91).

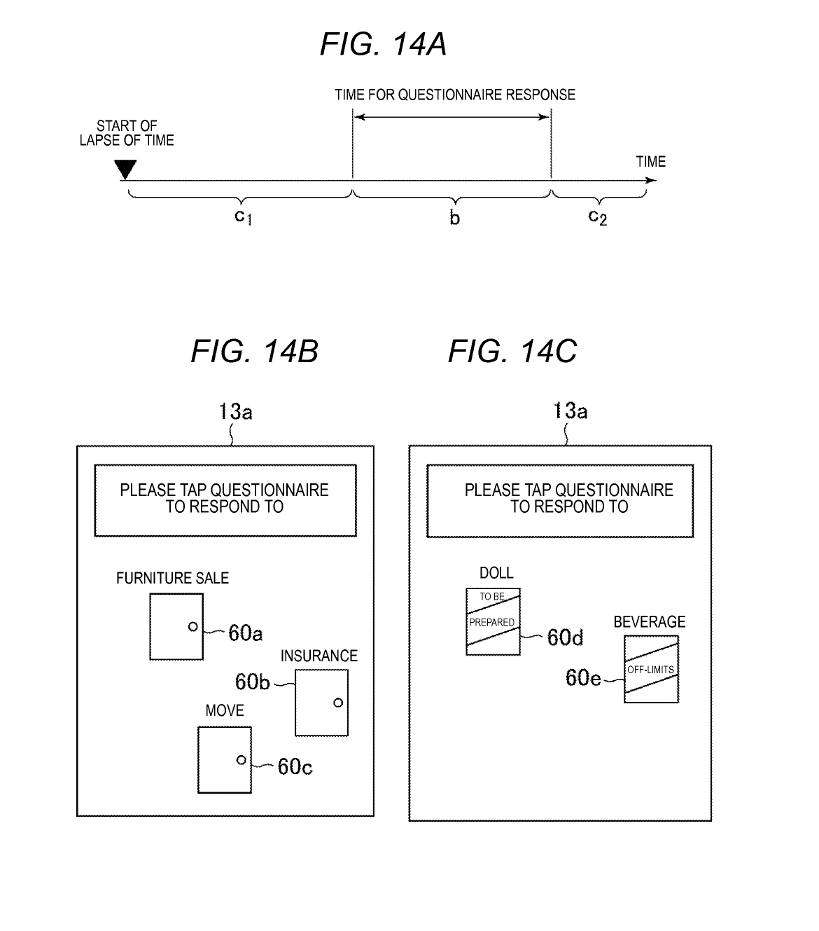

All the questionnaires included in the questionnaire group displayed in step S79 do not need to be in a response-enabled state. FIGS. 14(a) to 14(c) are diagrams illustrating a response-enabled/disabled state of a questionnaire on the display screen in the system according to the embodiment of the second invention, where FIG. 14(a) is a diagram illustrating that the response-enabled/disabled state of a questionnaire varies with the lapse of time from a counting start. FIGS. 14(b) and 14(c) are diagrams illustrating a difference in display of a questionnaire survey item in the time series illustrated in FIG. 14(a).

For example, when it is wanted to limit a respondent's response to a next questionnaire in a predetermined period of time after the respondent acquires privilege information by responding to a questionnaire, a time counting process is designed to be started at the timing at which the response to the first questionnaire is completed. By this design, a response to a questionnaire is enabled in a questionnaire response-enabled time b after a predetermined time c₁ elapses after the start of the time counting process in FIG. 14(a). Here, a response to a questionnaire may be enabled immediately after the time counting process is started without providing the predetermined time c₁ or a response may be normally enabled without providing a time in which a response to a questionnaire is disabled. The time counting process may be started in the questionnaire response device 1 after the update data is received in step S75.

On the other hand, a period of a campaign or the like may be designated without using the time counting process to determine whether a response to a questionnaire is enabled. For example, a period of January 1 to January 7 may be set to New Year sale, that is, privilege information may be acquired by responding to a questionnaire during a predetermined period of time. Without being limited to the lapse of a predetermined time or a designated period, the questionnaire response-enabled time b can be set, for example, in consideration of questionnaire response circumstances. For example, a condition in which a response to a questionnaire of automobile insurance is disabled without responding to a questionnaire of automobile may be set. By this design, it is possible to express priority or correlation between questionnaires.

Display details on the display screen 13a of the questionnaire response device 1 in time zones in FIG. 14(a) will be described below. For example, in the questionnaire response-enabled time b of FIG. 14(a), the details illustrated in FIG. 14(b) is displayed on the display screen 13a. Doors of furniture sale 60a, insurance 60b, and move 60c indicate entrances of corresponding questionnaire survey items and it is possible to respond to the questionnaires when a respondent selects one by tapping or the like.

On the other hand, in the time other than the questionnaire response-enabled time b in FIG. 14(a), that is, in questionnaire response-disabled times c₁ and c₂, details illustrated in FIG. 14(c) are displayed on the display screen 13a. For example, “in preparation”, like doll 60d, is displayed for the questionnaire in the questionnaire response-disabled time c₁ from the start of the time of FIG. 14(a) counting to the questionnaire response-enabled time and thus a respondent can understood that the questionnaire response-enabled time does not come in. On the other hand, in the questionnaire response-disabled time c₂ after the questionnaire response-enabled time b elapses, “off-limits”, like beverage 60e, is displayed so as to allow a user to understand that the questionnaire response-enabled time elapses. The questionnaire which has been used by a user may be changed to display of “off-limits”.

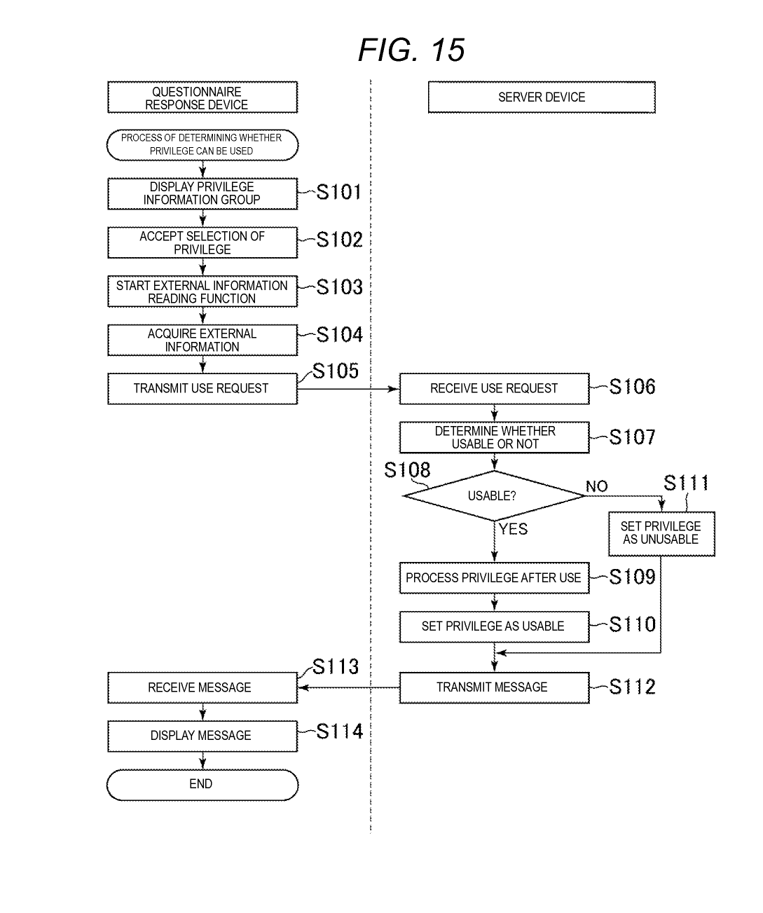

A situation in which a respondent uses the acquired privilege information will be described below. FIG. 15 is a diagram illustrating a flowchart of a process of determining whether privilege information can be used in the system according to the embodiment of the second invention.

When a respondent wants to use the acquired privilege information, the respondent visits a store in which the privilege will be executed and displays an acquired privilege information group on the display screen 13a of the questionnaire response device 1 (step S101). Then, when the respondent selects the privilege information to be used (step S102), the questionnaire response device 1 starts, for example, a function for reading a barcode, a QR code (registered trademark), or infrared information (step S103). The function of reading external information may be a camera function or a sensor function. When the questionnaire response device 1 reads the external information (step S104), identification information of the privilege information to be used, the read external information, and the information which can be acquired by the questionnaire response device 1 are transmitted as a use request to the server device 3 (step S105). Examples of the information which can be acquired by the questionnaire response device 1 include position information based on GPS or time information of the questionnaire response device 1.

The server device 3 receives the use request (step S106), and determines whether the privilege information can be used (step S107) by comparing the identification information of the privilege information stored in the HDD 33 with the identification information of the privilege information included in the use request. For example, by providing identification information for each respondent even in case of the same privilege information, it is possible to prevent a single use from enjoying the privilege plural times.

When it is determined that the privilege can be used (YES in step S108), data of the corresponding privilege information in a management table or the like stored in the HDD 33 is set to be used (step S109) and a message indicating that the respondent can use the privilege information is set (step S110). When it is determined that the privilege information cannot be used (NO in step S108), the privilege is used already or the expiration date ends and thus a message indicating that the privilege information is invalid is set (step S111). The set message is transmitted to the questionnaire response device 1 (step S112). The questionnaire response device 1 receives the message (step S 113) and displays the message on the display screen 13a (step S114). When the displayed message indicates that the privilege information can be used, the respondent can enjoy the privilege in the store.

In the above-mentioned example, by transmitting the use request including position information based on the GPS or the like, it is possible to understand a store in which the privilege is used. For example, when the privilege is used in a franchise store, a sales promotion premium may be paid depending on the number of times in which the privilege is used therein. In this case, each store promotes a client to use the privilege and a respondent as the client responds to questionnaire to acquire more privilege information.

In the above-mentioned example, the transmission time information may be included in the use request at the time of transmitting the use request. By combining the time information at which the privilege is used and the attribute information such as age and sex of the respondent, it is possible to collect data of user information for each time zone and thus to enable marketing analysis.

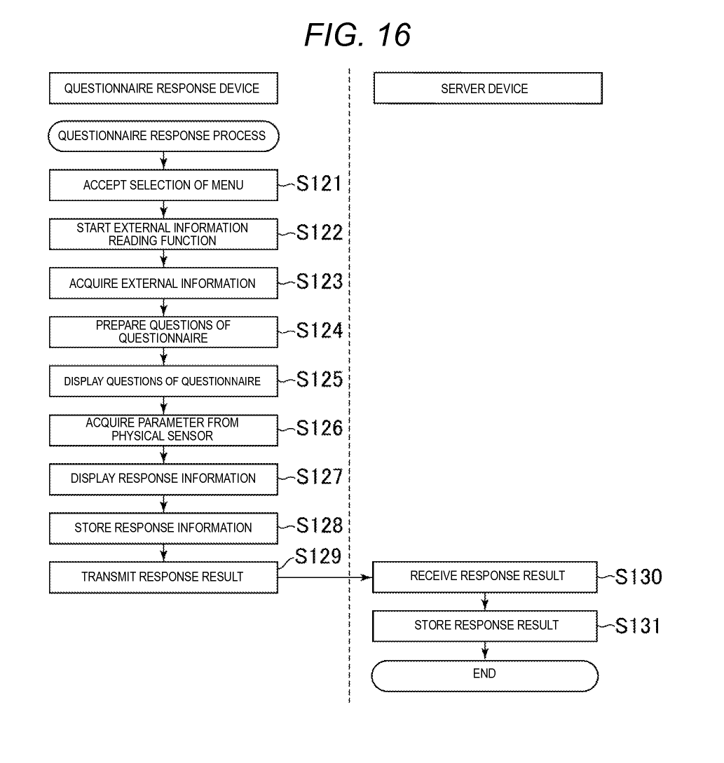

A questionnaire system in which a respondent can select a product or the like for which the respondent responds to a questionnaire will be described below. FIG. 16 is a diagram illustrating a flowchart of a process of responding to a questionnaire to which a respondent can select a product or the like to respond in the system according to the embodiment of the second invention.

When a respondent finds out a product, a service, or the like to respond to, the respondent selects a questionnaire response menu of the questionnaire response device 1 (step S121). The questionnaire response device 1 starts a function of reading external information (step S122). Here, when the respondent causes the questionnaire response device 1 to read the external information, for example, information of a barcode of a product (step S123), the questionnaire response device combines the read external information with question items of a template stored in the application to prepare questions of a questionnaire (step S124). The questionnaire response device displays the prepared questions on the display screen (step S125), receives a response from the respondent (step S126), displays response information (step S127), and stores the response information in the storage device (S128).

Then, the questionnaire response device transmits the response result to the server device 3 (step S129). The server device 3 receives the response result (step S130) and stores the received response result in the storage device (step S 131). The response result may include the information which can be acquired by the questionnaire response device 1, for example, information of position and time at the time of transmission, in addition to the response information of the respondent to the questionnaire. As a result, it is possible to enable local or time-series analysis of the questionnaire response.

In the second invention, classes of respondents may be set. Regarding the classes, for example, copper, silver, and gold classes may be sequentially set to rise in class, and conditions for registration in the classes may be determined, for example, such that respondents whose information such as sex and birth date is registered are in the copper class, respondents whose information such as housemate or yearly income is registered are in the silver class, and respondents whose information such as driver's license or qualification is additionally registered are in the gold class.

For example, in a questionnaire system in which a respondent can select a product or the like to respond to in a questionnaire, a plan of giving a privilege to one respondent every day may be executed to promote respondents to respond to the questionnaire. By setting the classes of respondents, this plan may be designed such that three times the number of respondents in the copper class can enter for the gold class. A restriction that only respondents in a predetermined class or higher can respond may be set as a response requirement for a questionnaire.

### REFERENCE SIGNS LIST

1 questionnaire response device

11 control section

12 RAM

13 display section

14 flash memory

15 communication interface

16 physical sensor section

2 communication network

3 server device

31 control section

32 RAM

33 HDD

34 communication interface

35 product information database

36 response information database

37 sensitivity difference correction value database

1. A questionnaire system that collects response information to a questionnaire from a respondent to the questionnaire, comprising:
a questionnaire response device that includes a display section displaying a response result to the questionnaire on a display screen and at least one type of physical sensor selected from a touch sensor, a gyro sensor, an acceleration sensor, a pressure sensor, an illuminance sensor, a camera, and a microphone; and
a server device that is capable of communicating with the questionnaire response device via a communication line, and
the questionnaire response device includes
a response information acquirer that acquires response information on a physical action on the questionnaire response device and/or outside circumstances of the questionnaire response device, which are sensed by the physical sensor,
a displayer that displays a response result to the questionnaire on a display screen based on the response information acquired by the response information acquirer, and
a response information transmitter that transmits the response information to the server device, and
the server device includes
a response information receiver that receives the response information transmitted from the questionnaire response device, and
a response information storage that stores the response information received by the response information receiver.

2. The questionnaire system according to claim 1, wherein the response information is a parameter indicating the physical action on the questionnaire response device and/or the outside circumstances of the questionnaire response device, which are sensed by the physical sensor.

3. The questionnaire system according to claim 1, wherein the response information is converted into information corresponding to the response result to the questionnaire based on a parameter indicating the physical action on the questionnaire response device and/or the outside circumstances of the questionnaire response device, which are sensed by the physical sensor.

4. The questionnaire system according to claim 1, wherein the questionnaire response device further includes:
a local application storage that stores a local application capable of implementing the response information acquirer, the displayer, and the response information transmitter by combination with a customiable part including at least one type of data selected from a text, an image, a voice, and a video constituting questions of an individual questionnaire survey item;
a customizable part storage that stores the customizable part; and
an application constructer that constructs an application relevant to a response to the questionnaire by combining the local application stored in the local application storage and the customizable part stored in the customizable part storage, and
wherein the application causes the questionnaire response device to serve as the response information acquirer, the displayer, and the response information transmitter and causes the displayer to display the question contents of the individual questionnaire survey item corresponding to the customizable part on the display screen.

5. The questionnaire system according to claim 1, wherein the server device further includes:
a product information storage that stores product information;
a recommended product information selecter that selects product information to be recommended to the respondent to the questionnaire from the product information stored in the product information storage based on score information which is acquired by scoring the response information stored in the response information storage; and
a recommended product information transmitter that transmits the product information selected by the recommended product information selecter to the questionnaire response device, and
wherein the questionnaire response device further includes:
a recommended product information receiver that receives the product information from the server device; and
a recommended product information displayer that displays the product information received by the recommended product information receiver.

6. The questionnaire system according to claim 1, wherein the questionnaire response device further includes:
a specification information storage that stores specification information of hardware specifications of the questionnaire response device; and
a first response information correcter that calculates a sensitivity value of the physical sensor of the questionnaire response device from the specification information stored in the specification information storage and corrects the response information acquired by the response information acquirer based on the calculated sensitivity value, and
wherein the response information transmitter transmits the response information corrected by the first response information correcter to the server device.

7. The questionnaire system according to claim 1, wherein the server device further includes:
a sensitivity difference correction value storage that stores a sensitivity difference correction value for correcting a sensitivity difference of the physical sensor depending on a specification difference between the hardware specifications of the questionnaire response device in advance; and
a second response information correcter that corrects the response information stored in the response information storage based on the sensitivity difference correction value stored in the sensitivity difference correction value storage, and
wherein the response information storage stores the response information corrected by the second response information correcter.

8. The questionnaire system according to claim 1, wherein the questionnaire response device further includes:
a formal parameter acquirer that acquires a formal parameter indicating the physical action on the questionnaire response device and/or the outside circumstances of the questionnaire response device and corresponding to at least one response to the questions of the questionnaire when the respondent to a questionnaire practices prior to response; and
a third response information correcter that corrects the response information acquired by the response information acquirer based on the formal parameter acquired by the formal parameter acquirer, and
wherein the response information transmitter transmits the response information corrected by the third response information correcter to the server device.

9. The questionnaire system according to claim 1, wherein the questionnaire response device further includes:
a response information storage that stores the response information acquired by the response information acquirer;
a communication restoration detecter that detects restoration when the communication with the server device is cut off for a predetermined period of time and then the communication with the server device is restored; and
a questionnaire response information re-transmitter that re-transmits the response information stored in the response information storage to the server device when the restoration of the communication with the server device is detected by the communication restoration detecter.

10. A questionnaire response device having a display section displaying a response result to a questionnaire on a display screen and at least one type of physical sensor selected from a touch sensor, a gyro sensor, an acceleration sensor, a pressure sensor, an illuminance sensor, a camera, and a microphone, comprising:
a response information acquirer that acquires response information on a physical action on the questionnaire response device and/or outside circumstances of the questionnaire response device, which are sensed by the physical sensor;
a displayer that displays a response result to the questionnaire on a display screen based on the response information acquired by the response information acquirer; and
a response information transmitter that transmits the response information to the server device.

11. A questionnaire response method of causing a computer system to collect response information to a questionnaire from a respondent to the questionnaire, comprising the steps of:
acquiring a response information; acquiring the response information on a physical action on a questionnaire response device and/or outside circumstances of the questionnaire response device, which are sensed by a physical sensor;
displaying; displaying a response result to the questionnaire on a display screen based on the response information acquired in the acquiring response information step; and
transmitting a response information; transmitting the response information to the server device.

12-17. (canceled)
